(19) United States
(12) Patent Application Publication
(10) Pub. No.: US 2022/0256151 A1
(43) Pub. Date: Aug. 11, 2022

(54) IMAGE PROCESSING DEVICE AND METHOD

(71) Applicant: Sony Group Corporation, Tokyo (JP)

(72) Inventor: Takeshi TSUKUBA, Tokyo (JP)

(73) Assignee: Sony Group Corporation, Tokyo (JP)

(21) Appl. No.: 17/628,232

(22) PCT Filed: Aug. 21, 2020
(86) PCT No.: PCT/JP2020/031688

§ 371 Date: Jan. 19, 2022

Related U.S. Application Data
(60) Provisional application No. 62/891,085, filed on Aug. 23, 2019.

(51) Int. Cl. H04N 19/122; H04N 19/176; H04N 19/124

(52) U.S. Cl. CPC H04N 19/122; H04N 19/124; H04N 19/176

(57) ABSTRACT

The present disclosure relates to an image processing device and method capable of curbing an increase in a coding/decoding load.

A maximum transform block size in a lossless coding mode is set to the same size as a transform coefficient group corresponding to a maximum transform block size in a non-lossless coding mode. The present disclosure can be applied to, for example, an image processing device, an image coding device, an image decoding device, a transmitting device, a receiving device, a transmitting/receiving device, an information processing device, an imaging device, a reproducing device, an electronic apparatus, an image processing method, an information processing method, and the like.

### TECHNICAL FIELD

The present disclosure relates to an image processing device and method, and particularly, to an image processing device and method capable of suppressing an increase in a coding/decoding load.

### BACKGROUND ART

Conventionally, a coding method of deriving a predicted residual of a moving image and performing coefficient transformation, quantization, and coding has been proposed (for example, NPL 1). In addition, in such image coding, lossless coding in which coefficient transformation, quantization and the like are skipped (omitted) and a predicted residual is losslessly coded has been proposed (for example, NPL 2).

In VTM of NPL 1, when a transform block size is 64×64, high frequency components are zeroed out and a buffer for holding transform coefficients corresponding to 32×32 is necessary. That is, a buffer size necessary to hold the transform coefficients is 32*32*16 bits=16,384 bits.

### CITATION LIST

### Non Patent Literature

[NPL 1]

VTM-5.0 in https://vcgit.hhi.fraunhofer.de/jvet/VVCSoftware_VTM

[NPL 2]

Tsung-Chuan Ma, Yi-Wen Chen, Xiaoyu Xiu, Xianglin Wang, Tangi Poirier, Fabrice Le Leannec, Karam Naser, Edouard Francois, Hyeongmun Jang, Junghak Nam, Naeri Park, Jungah Choi, Seunghwan Kim, Jaehyun Lim, “Lossless coding for VVC”, JVET-O1061, m49678, Joint Video Experts Team (JVET) of ITU-T SG 16 WP 3 and ISO/IEC JTC 1/SC 29/WG 11 15th Meeting: Gothenburg, SE, 3-12 Jul. 2019

### SUMMARY

### Technical Problem

On the other hand, in the method described in NPL 2, the buffer size for holding transform coefficients is expanded to 64×64 in order to support lossless coding in a 128×128 coding unit (CU). That is, the buffer size necessary to hold transform coefficients is 64*64*16 bits=65,536 bits, which is four times the buffer size necessary in VTM. That is, a load of coding and decoding may increase.

The present disclosure has been devised in view of such circumstances and an object of the present disclosure is to curb an increase in a coding/decoding load.

### Solution to Problem

An image processing device of one aspect of the present technology is an image processing device including a control unit configured to set a maximum transform block size in a lossless coding mode to the same size as a transform coefficient group corresponding to a maximum transform block size in a non-lossless coding mode,

a transform quantization unit configured to generate a quantization coefficient by performing coefficient transformation and quantization on a predicted residual of an image in the case of the non-lossless coding mode and to skip the coefficient transformation and the quantization for the predicted residual in the case of the lossless coding mode, and a coding unit configured to code the quantization coefficient generated by the transform quantization unit in the case of the non-lossless coding mode and to code the predicted residual in the case of the lossless coding mode.

An image processing method of one aspect of the present technology is an image processing method including setting a maximum transform block size in a lossless coding mode to the same size as a transform coefficient group corresponding to a maximum transform block size in a non-lossless coding mode, generating a quantization coefficient by performing coefficient transformation and quantization on a predicted residual of an image in the case of the non-lossless coding mode and skipping the coefficient transformation and the quantization for the predicted residual in the case of the lossless coding mode, and coding the generated quantization coefficient in the case of the non-lossless coding mode and coding the predicted residual in the case of the lossless coding mode.

An image processing device of another aspect of the present technology is an image processing device including a control unit configured to estimate a maximum transform block size in a lossless coding mode as the same size as a transform coefficient group corresponding to a maximum transform block size in a non-lossless coding mode,

a decoding unit configured to decode coded data to generate a quantization coefficient in the case of the non-lossless coding mode and to decode the coded data to generate a predicted residual of an image in the case of the lossless coding mode, and an inverse quantization inverse transformation unit configured to generate the predicted residual by performing inverse quantization and inverse coefficient transformation on the quantization coefficient generated by the decoding unit in the case of the non-lossless coding mode and to skip the inverse quantization and the inverse coefficient transformation for the predicted residual generated by the decoding unit in the case of the lossless coding mode.

An image processing method of another aspect of the present technology is an image processing method including estimating a maximum transform block size in a lossless coding mode as the same size as a transform coefficient group corresponding to a maximum transform block size in a non-lossless coding mode, decoding coded data to generate a quantization coefficient in the case of the non-lossless coding mode and decoding the coded data to generate a predicted residual of an image in the case of the lossless coding mode, and generating the predicted residual by performing inverse quantization and inverse coefficient transformation on the generated quantization coefficient in the case of the non-lossless coding mode and skipping the inverse quantization and the inverse coefficient transformation for the generated predicted residual in the case of the lossless coding mode.

In the image processing device and method of one aspect of the present technology, a maximum transform block size in the lossless coding mode is set to the same size as a transform coefficient group corresponding to a maximum transform block size in the non-lossless coding mode, a quantization coefficient is generated by performing coefficient transformation and quantization on a predicted residual of an image in the case of the non-lossless coding mode, the coefficient transformation and the quantization for the predicted residual are skipped in the case of the lossless coding mode, the generated quantization coefficient is coded in the case of the non-lossless coding mode, and the predicted residual is coded in the case of the lossless coding mode.

In the image processing device and method of another aspect of the present technology, a maximum transform block size in the lossless coding mode is estimated as the same size as a transform coefficient group corresponding to a maximum transform block size in the non-lossless coding mode, coded data is decoded to generate a quantization coefficient in the case of the non-lossless coding mode, the coded data is decoded to generate a predicted residual of an image in the case of the lossless coding mode, the predicted residual is generated by performing inverse quantization and inverse coefficient transformation on the generated quantization coefficient in the case of the non-lossless coding mode, and the inverse quantization and the inverse coefficient transformation for the generated predicted residual are skipped in the case of the lossless coding mode.

### BRIEF DESCRIPTION OF DRAWINGS

FIG. 1 is a diagram illustrating an example of a control method in a lossless coding mode.

FIG. 2 is a block diagram showing an example of a main configuration of an image coding device.

FIG. 3 is a block diagram showing an example of a main configuration of a transform quantization unit.

FIG. 4 is a diagram illustrating an example of a maximum transform block size.

FIG. 5 is a flowchart showing an example of a flow of image coding processing.

FIG. 6 is a flowchart illustrating an example of a flow of transform quantization processing.

FIG. 7 is a block diagram showing an example of a main configuration of an image decoding device.

FIG. 8 is a block diagram showing an example of a main configuration of an inverse quantization inverse transformation unit.

FIG. 9 is a flowchart showing an example of a flow of image decoding processing.

FIG. 10 is a flowchart showing an example of a flow of inverse quantization and inverse transformation processing.

FIG. 11 is a diagram illustrating an example of semantics in method 1-2 and method 2-2.

FIG. 12 is a diagram illustrating an example of syntaxes in method 1-2 and method 2-2.

FIG. 13 is a diagram illustrating a transform quantization bypass flag.

FIG. 14 is a diagram illustrating an example of semantics and syntaxes in method 1-3 and method 2-3.

FIG. 15 is a diagram illustrating an example of semantics in method 1-4 and method 2-4.

FIG. 16 is a diagram illustrating an example of syntaxes in method 1-4 and method 2-4.

FIG. 17 is a diagram illustrating an example of semantics and syntaxes in method 1-5 and 2-5.

FIG. 18 is a diagram illustrating an example of semantics and syntaxes in method 1-6 and 2-6.

FIG. 19 is a block diagram showing an example of a main configuration of a computer.

### DESCRIPTION OF EMBODIMENTS

Hereinafter, modes for carrying out the present disclosure (hereinafter referred as embodiment) will be described. The description will be made in the following order.

1. Maximum transform block size control in lossless coding mode

2. First embodiment (image coding device)

3. Second embodiment (image decoding device)

4. Luminance maximum transform block size control

5. Maximum coding tree unit size control

6. Application control of lossless coding mode

7. Supplement

### 1. Control of Maximum Transform Block Size in Lossless Coding Mode

<Literature and the Like that Support Technical Content and Technical Terms>

The scope disclosed in the present technology is not limited to the content described in embodiments and also includes the content described in NPL below and the like that were known at the time of filing and the content of other literature referred to in NPL below.

[NPL 1] (described above)

[NPL 2] (described above)

[NPL 3]

Benjamin Bross, Jianle Chen, Shan Liu, “Versatile Video Coding (Draft 5)”, N1001-v10, m48053, Joint Video Experts Team (JVET) of ITU-T SG 16 WP 3 and ISO/IEC JTC 1/SC 29/WG 11 14th Meeting: Geneva, CH, 19-27 Mar. 2019

[NPL 4]

Jianle Chen, Yan Ye, Seung Hwan Kim, “Algorithm description for Versatile Video Coding and Test Model 5 (VTM 5)”, JVET-N1002-v2, m48054, Joint Video Experts Team (JVET) of ITU-T SG 16 WP 3 and ISO/IEC JTC 1/SC 29/WG 11 14th Meeting: Geneva, CH, 19-27 Mar. 2019

[NPL 5]

Benjamin Bross, Jianle Chen, Shan Liu, “Versatile Video Coding (Draft 6)”, JVET-O2001-vE, m49908, Joint Video Experts Team (JVET) of ITU-T SG 16 WP 3 and ISO/IEC JTC 1/SC 29/WG 11 15th Meeting: Gothenburg, SE, 3-12 Jul. 2019

[NPL 6]

Jianle Chen, Yan Ye, Seung Hwan Kim, “Algorithm description for Versatile Video Coding and Test Model 6 (VTM 6)”, JVET-O2002-v2, m49914, Joint Video Experts Team (JVET) of ITU-T SG 16 WP 3 and ISO/IEC JTC 1/SC 29/WG 11 15th Meeting: Gothenburg, SE, 3-12 Jul. 2019

[NPL 7]

Tsung-Chuan Ma, Yi-Wen Chen, Xiaoyu Xiu, Xianglin Wang, “Modifications to support the lossless coding”, JVET-O0591, m48730, Joint Video Experts Team (JVET) of ITU-T SG 16 WP 3 and ISO/IEC JTC 1/SC 29/WG 11 15th Meeting: Gothenburg, SE, 3-12 Jul. 2019

[NPL 8]

Hyeongmun Jang, Junghak Nam, Naeri Park, Jungah Choi Seunghwan Kim, Jaehyun Lim, “Comments on transform quantization bypassed mode”, JVET-O0584, m48723, Joint Video Experts Team (JVET) of ITU-T SG 16 WP 3 and ISO/IEC JTC 1/SC 29/WG 11 15th Meeting: Gothenburg, SE, 3-12 Jul. 2019

[NPL 9]

Tangi Poirier, Fabrice Le Leannec, Karam Naser, Edouard Francois, “On lossless coding for VVC”, JVET-O0460, m48583, Joint Video Experts Team (JVET) of ITU-T SG 16 WP 3 and ISO/IEC JTC 1/SC 29/WG 11 15th Meeting: Gothenburg, SE, 3-12 Jul. 2019

[NPL 10]

Recommendation ITU-T H.264 (04/2017) “Advanced video coding for generic audiovisual services”, April 2017

[NPL 11]

Recommendation ITU-T H.265 (02/18) “High efficiency video coding”, February 2018

That is, the content described in the above-described NPL is also the grounds when supporting requirements are determined. For example, even though the Quad-Tree Block Structure and the Quad Tree Plus Binary Tree (QTBT) Block Structure described in the above-described NPL are not explicitly described in embodiments, they are assumed to be included in the scope of disclosure of the present technology and to satisfy support requirements of the claims. In addition, even though technical terms such as parsing, syntax, and semantics are not explicitly described in embodiments, they are assumed to be included in the scope of disclosure of the present technology and to satisfy support requirements of the claims.

Further, in the present specification, “block” (not a block indicating a processing unit) used for description of a partial area of an image (picture) or a processing unit indicates an arbitrary partial area in the picture unless otherwise mentioned, and the size, shape, characteristics, etc. thereof are not limited. For example, “block” is assumed to include an arbitrary partial area (processing unit) such as a transform block (TB), a transform unit (TU), a prediction block (PB), a prediction unit (PU), a smallest coding unit (SCU), a coding unit (CU), a largest coding unit (LCU), a coding tree block (CTB), a coding tree unit (CTU), a subblock, a macroblock, a tile, a slice, etc. described in the above-described NPL.

In addition, in designation of the size of such a block, not only may the block size may be directly designated, but the block size may also be indirectly designated. For example, a block size may be designated using identification information that identifies a size. Further, for example, a block size may be designated by a ratio or difference with respect to the size of a reference block (for example, LCU, SCU, or the like). For example, when information for designating a block size is transmitted as a syntax element or the like, information for indirectly designating the size as described above may be used as the information. In this way, the amount of information may be reduced and the coding efficiency may be improved. Further, designation of the block size also includes designation of a range of the block size (for example, designation of a range of allowable block sizes, and the like).

In addition, in the present specification, coding includes not only whole processing of transforming an image into a bitstreams but also a part of processing. For example, coding includes not only processing including prediction processing, orthogonal transformation, quantization, arithmetic coding, and the like but also processing that collectively refers to quantization and arithmetic coding, processing including prediction processing, quantization, and arithmetic coding, and the like. Similarly, decoding includes not only whole processing of transforming bitstreams into an image but also a part of processing. For example, decoding includes not only processing including inverse arithmetic decoding, inverse quantization, inverse orthogonal transformation, prediction processing, and the like but also processing including inverse arithmetic decoding and inverse quantization, processing including inverse arithmetic decoding, inverse quantization, and prediction processing, and the like.

<Buffer Size>

NPL 2 discloses lossless coding, which is a coding method for losslessly coding a predicted residual by skipping (omitting) coefficient transformation, quantization, and the like in image coding of NPL 1.

VTM of NPL 1, when a transform block size is 64x64, high frequency components are zeroed out and a buffer for holding transform coefficients corresponding to 32×32 is necessary. That is, a buffer size necessary to hold the transform coefficients is 32*32*16 bits=16,384 bits.

On the other hand, in the method described in NPL 2, the buffer size for holding transform coefficients is expanded to 64×64 in order to support lossless coding in a 128×128 coding unit (CU). That is, a buffer size necessary to hold the transform coefficients is 64*64*16 bits=65,536 bits.

As described above, in the case of the method described in NPL 2, a buffer size four times larger than that in the case of VTM of NPL 1 is required. That is, a load of coding and decoding may increase. Therefore, a circuit scale may increase and manufacturing cost may increase, for example.

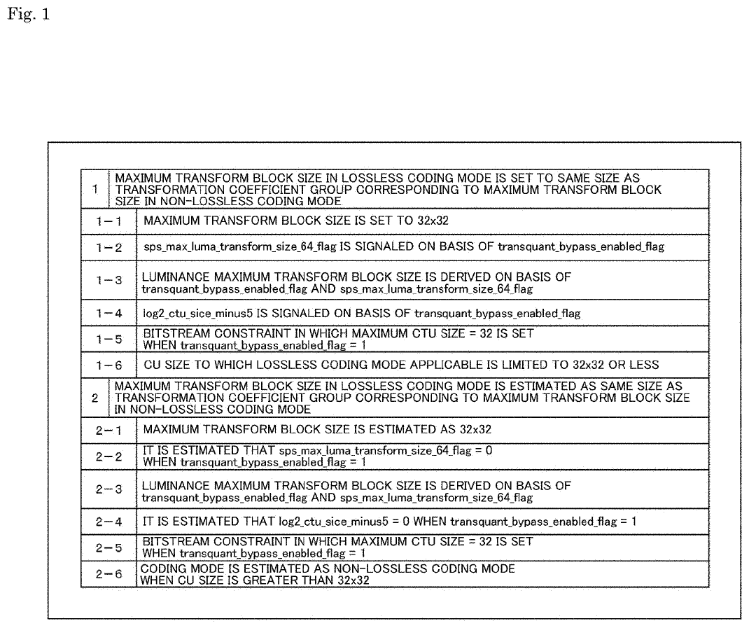

Therefore, on a coding side, a maximum transform block size of a lossless coding mode, which is a mode in which lossless coding is applied, is set to the same size as a transform coefficient group corresponding to a maximum transform block size of a non-lossless coding mode, which is a mode in which lossless coding is not applied (method 1), as shown in the first row (top row) from the top of the table in FIG. 1.

For example, in image processing, a maximum transform block size in the lossless coding mode is set to the same size as a transform coefficient group corresponding to a maximum transform block size in the non-lossless coding mode, a quantization coefficient is generated by performing coefficient transformation and quantization on a predicted residual of an image in the case of the non-lossless coding mode, coefficient transformation and quantization for the predicted residual are skipped in the case of the lossless coding mode, the generated quantization coefficient is coded in the case of the non-lossless coding mode, and the predicted residual is coded in the case of the lossless coding mode.

In addition, for example, an image processing device includes a control unit that sets a maximum transform block size in the lossless coding mode to the same size as a transform coefficient group corresponding to a maximum transform block size in the non-lossless coding mode, an inverse quantization unit that generates a quantization coefficient by performing coefficient transformation and quantization on a predicted residual of an image in the case of the non-lossless coding mode and skips coefficient transformation and quantization for the predicted residual in the case of the lossless coding mode, and a coding unit that codes the generated quantization coefficient in the case of the non-lossless coding mode and codes the predicted residual in the case of the lossless coding mode.

In this way, the buffer size necessary in the lossless coding mode can be set the same as the buffer size necessary in the non-lossless coding mode, and thus an increase in a coding load can be curbed. Further, this makes it possible to curb an increase in the circuit scale and cost of a device performing coding.

As described above, for example, in the VTM of NPL 1, when a transform block size is 64×64, high frequency components are zeroed out and a buffer for holding transform coefficients corresponding to 32×32 is necessary. Accordingly, the maximum transform block size in the lossless coded mode may be set to 32×32, as shown in the second row from the top of the table in FIG. 1 (method 1-1).

Further, on a decoding side, a maximum transform block size in the lossless coding mode, which is a mode in which lossless coding is applied, is estimated as the same size as a transform coefficient group corresponding to a maximum transform block size in the non-lossless coding mode, which is a mode in which lossless coding is not applied, as shown in the eighth row from the top of the table of FIG. 1 (method 2).

For example, in image processing, a maximum transform block size in the lossless coding mode is estimated as the same size as a transform coefficient group corresponding to a maximum transform block size in the non-lossless coding mode, coded data is decoded to generate a quantization coefficient in the case of the non-lossless coding mode, the coded data is decoded to generate a predicted residual of an image in the case of the lossless coding mode, a predicted residual is generated by performing inverse quantization and inverse coefficient transformation on the generated quantization coefficient in the case of the non-lossless coding mode, and inverse quantization and inverse coefficient transformation for the generated predicted residual are skipped in the case of the lossless coding mode.

Further, for example, an image processing device includes a control unit that estimates a maximum transform block size in the lossless coding mode as the same size as a transform coefficient group corresponding to a maximum transform block size in the non-lossless coding mode, a decoding unit that decodes coded data to generate a quantization coefficient in the case of the non-lossless coding mode and decodes the coded data to generate a predicted residual of an image in the case of the lossless coding mode, and an inverse quantization inverse transformation unit that generates a predicted residual by performing inverse quantization and inverse coefficient transformation on the quantization coefficient generated by the decoding unit in the case of the non-lossless coding mode and skips inverse quantization and inverse coefficient transformation for the predicted residual generated by the decoding unit in the case of the lossless coding mode.

In this way, the buffer size necessary in the lossless coding mode can be set to the same as the buffer size necessary in the non-lossless coding mode, and thus an increase in a decoding load can be curbed. Further, this makes it possible to curb an increase in the circuit scale and cost of a device performing decoding.

As described above, for example, the VTM of NPL 1, when a transform block size is 64×64, high frequency components are zeroed out and a buffer for holding transform coefficients corresponding to 32×32 is necessary. Accordingly, in the case of decoding as in the case of coding, the maximum transform block size in the lossless coded mode may be set to 32×32, as shown in the ninth row from the top of the table in FIG. 1 (Method 2-1).

### 2. First Embodiment

<Image Coding Device>

The present technology described in <1. Control of maximum transform block size in lossless coding mode> can be applied to any apparatus, device, system, and the like. For example, the present technology can be applied to an image coding device that codes image data.

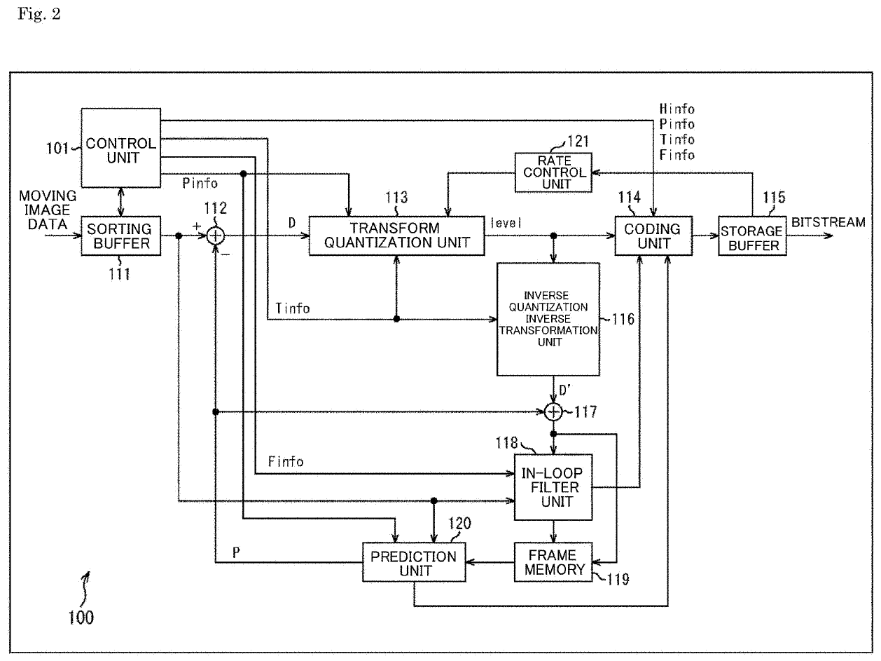

FIG. 2 is a block diagram showing an example of a configuration of an image coding device, which is an aspect of an image processing device to which the present technology is applied. The image coding device 100 shown in FIG. 2 is a device that codes image data of a moving image. For example, the image coding device 100 codes image data of a moving image using a coding method such as Versatile Video Coding (VVC), Advanced Video Coding (AVC), or High Efficiency Video Coding (HEVC) described in the above-described NPL.

FIG. 2 does not show all parts but shows only principal parts of processing units and data flows. That is, the image coding device 100 may include a processing unit that is not shown as a block in FIG. 2 or processing or a data flow that is not shown as an arrow or the like in FIG. 2. This also applies to other figures illustrating the processing units and the like in the image coding device 100.

As shown in FIG. 2, the image coding device 100 includes a control unit 101, a sorting buffer 111, an arithmetic operation unit 112, a transform quantization unit 113, a coding unit 114, and a storage buffer 115. Further, the image coding device 100 includes an inverse quantization inverse transformation unit 116, an arithmetic operation unit 117, an in-loop filter unit 118, a frame memory 119, a prediction unit 120, and a rate control unit 121.

<Control Unit>

The control unit 101 divides moving image data held by the sorting buffer 111 into blocks (CUs, PUs, TUs, etc.) in a processing unit on the basis of a block size in an external or predetermined processing unit. In addition, the control unit 101 determines coding parameters (header information Hinfo, prediction mode information Pinfo, transformation information Tinfo, filter information Finfo, etc.) to be supplied to each block on the basis of, for example, rate-distortion optimization (RDO). For example, the control unit 101 can set a transformation skip flag or the like.

Details of these coding parameters will be described later. When the control unit 101 determines the coding parameters as described above, the control unit 101 supplies them to each block. A specific description is as follows.

The header information Hinfo is supplied to each block. The prediction mode information Pinfo is supplied to the coding unit 114 and the prediction unit 120. The transformation information Tinfo is supplied to the coding unit 114, the transform quantization unit 113, and the inverse quantization inverse transformation unit 116. The filter information Finfo is supplied to the in-loop filter unit 118.

<Sorting Buffer>

Each field (input image) of moving image data is input to the image coding device 100 in a reproduction order (display order). The sorting buffer 111 acquires and holds (stores) input images in the reproduction order (display order) thereof. The sorting buffer 111 sorts the input images in a coding order (decoding order) or divides the input images into blocks in a processing unit on the basis of control of the control unit 101. The sorting buffer 111 supplies each processed input image to the arithmetic operation unit 112.

<Arithmetic Operation Unit>

The arithmetic operation unit 112 subtracts a predicted image P supplied from the prediction unit 120 from the image corresponding to the blocks in the processing unit supplied from the sorting buffer 111 to derive residual data D and supplies the residual data D to the transform quantization unit 113.

<Transform Quantization Unit>

The transform quantization unit 113 performs processing related to coefficient transformation and quantization. For example, the transform quantization unit 113 acquires the residual data D supplied from the arithmetic operation unit 112. In the case of the non-lossless coding mode, the transform quantization unit 113 performs coefficient transformation such as orthogonal transformation on the residual data D to derive a transform coefficient Coeff. The transform quantization unit 113 scales (quantizes) the transform coefficient Coeff to derive a quantization coefficient level. The transform quantization unit 113 supplies the quantization coefficient level to the coding unit 114 and the inverse quantization inverse transformation unit 116.

The transform quantization unit 113 can skip (omit) coefficient transformation and quantization. In the case of the lossless coding mode, the transform quantization unit 113 skips coefficient transformation and quantization and supplies the acquired residual data D to the coding unit 114 and the inverse quantization inverse transformation unit 116.

The transform quantization unit 113 performs such processing according to control of the control unit 101. For example, the transform quantization unit 113 can perform such processing on the basis of the prediction mode information Pinfo and the transformation information Tinfo supplied from the control unit 101. Further, the rate of quantization performed by the transform quantization unit 113 is controlled by the rate control unit 121.

<Coding Unit>

The coding unit 114 receives the quantization coefficient level (or residual data D) supplied from the transform quantization unit 113, the various coding parameters (header information Hinfo, prediction mode information Pinfo, transformation information Tinfo, filter information Finfo, etc.) supplied from the control unit 101, information on a filter such as a filter coefficient supplied from the in-loop filter unit 118, and information on an optimum prediction mode supplied from the prediction unit 120.

The coding unit 114 performs, for example, entropy coding (reversible coding) such as Context-based Adaptive Binary Arithmetic Code (CABAC) or Context-based Adaptive Variable Length Code (CAVLC) on the quantization coefficient level or the residual data D to generate a bit string (coded data). For example, when CABAC is applied, the coding unit 114 performs arithmetic coding using a context model on the quantization coefficient level in the non-lossless coding mode to generate coded data. Further, in the lossless coding mode, the coding unit 114 performs arithmetic coding on the residual data D in a bypass mode to generate coded data.

In addition, the coding unit 114 derives residual information Rinfo from the quantization coefficient level and the residual data and codes the residual information Rinfo to generate a bit string.

Further, the coding unit 114 includes the information on the filter supplied from the in-loop filter unit 118 in the filter information Finfo and includes the information on the optimum prediction mode supplied from the prediction unit 120 in the prediction mode information Pinfo. Then, the coding unit 114 codes the various coding parameters (header information Hinfo, prediction mode information Pinfo, transformation information Tinfo, filter information Finfo, etc.) described above to generate a bit string.

In addition, the coding unit 114 multiplexes the bit strings of the various types of information generated as described above to generate coded data. The coding unit 114 supplies the coded data to the storage buffer 115.

<Storage Buffer>

The storage buffer 115 temporarily holds the coded data obtained in the coding unit 114. The storage buffer 115 outputs the held coded data as, for example, a bitstream or the like, to the outside of the image coding device 100 at a predetermined timing. For example, this coded data is transmitted to a decoding side via an arbitrary recording medium, an arbitrary transmission medium, an arbitrary information processing device, or the like. That is, the storage buffer 115 is also a transmission unit that transmits coded data (a bitstream).

<Inverse Quantization Inverse Transformation Unit>

The inverse quantization inverse transformation unit 116 performs processing related to inverse quantization and inverse coefficient transformation. For example, in the case of the non-lossless coding mode, the inverse quantization inverse transformation unit 116 receives the quantization coefficient level supplied from the transform quantization unit 113 and the transformation information Tinfo supplied from the control unit 101. The inverse quantization inverse transformation unit 116 scales (inversely quantizes) the value of the quantization coefficient level on the basis of the transformation information Tinfo to derive a transform coefficient Coeff. This inverse quantization is inverse processing of quantization performed in the transform quantization unit 113. Further, the inverse quantization inverse transformation unit 116 performs inverse coefficient transformation (for example, inverse orthogonal transformation) on the transform coefficient Coeff on the basis of the transformation information Tinfo to derive residual data D′. This inverse coefficient transformation is inverse processing of coefficient transformation performed in the transform quantization unit 113. The inverse quantization inverse transformation unit 116 supplies the derived residual data D′ to the arithmetic operation unit 117.

The inverse quantization inverse transformation unit 116 can skip (omit) inverse quantization and inverse coefficient transformation. For example, when the lossless coding mode is applied, the inverse quantization inverse transformation unit 116 receives the residual data D supplied from the transform quantization unit 113 and the transformation information Tinfo supplied from the control unit 101. The inverse quantization inverse transformation unit 116 skips inverse quantization and inverse coefficient transformation and supplies the residual data D (as the residual data D′) to the arithmetic operation unit 117.

Since the inverse quantization inverse transformation unit 116 is the same as the inverse quantization inverse transformation unit (which will be described later) on the decoding side, description of the decoding side (which will be described later) can be applied to the inverse quantization inverse transformation unit 116.

<Arithmetic Operation Unit>

The arithmetic operation unit 117 receives the residual data D′ supplied from the inverse quantization inverse transformation unit 116 and the predicted image P supplied from the prediction unit 120. The arithmetic operation unit 117 adds the residual data D′ and a predicted image corresponding to the residual data D′ to derive a locally decoded image. The arithmetic operation unit 117 supplies the derived locally decoded image to the in-loop filter unit 118 and the frame memory 119.

<In-Loop Filter Unit>

The in-loop filter unit 118 performs processing related to in-loop filter processing. For example, the in-loop filter unit 118 receives the locally decoded image supplied from the arithmetic operation unit 117, the filter information Finfo supplied from the control unit 101, and the input image (original image) supplied from the sorting buffer 111. Meanwhile, information input to the in-loop filter unit 118 is arbitrary and information other than this information may be input. For example, a prediction mode, motion information, a code amount target value, a quantization parameter QP, a picture type, information on blocks (CUs, CTUs, and the like), and the like may be input to the in-loop filter unit 118 as necessary.

The in-loop filter unit 118 appropriately filters the locally decoded image on the basis of the filter information Finfo. The in-loop filter unit 118 also uses the input image (original image) and other input information for filter processing as necessary.

For example, the in-loop filter unit 118 can apply four in-loop filters: a bilateral filter, a deblocking filter (DBF), an adaptive offset filter (sample adaptive offset (SAO)), and an adaptive loop filter (ALF) in that order. Which filter is applied and in which order they are applied are arbitrary and can be appropriately selected.

Of course, filter processing performed by the in-loop filter unit 118 is arbitrary and is not limited to the above example. For example, the in-loop filter unit 118 may apply a Wiener filter or the like.

The in-loop filter unit 118 supplies the filtered locally decoded image to the frame memory 119. When information on the filter, such as the filter coefficient, is transmitted to the decoding side, the in-loop filter unit 118 supplies the information on the filter to the coding unit 114.

<Frame Memory>

The frame memory 119 performs processing related to storage of data regarding images. For example, the frame memory 119 receives the locally decoded image supplied from the arithmetic operation unit 117 and the filtered locally decoded image supplied from the in-loop filter unit 118 and holds (stores) them. In addition, the frame memory 119 reconstructs a decoded image for each picture unit using the locally decoded image and holds the decoded image (stores the decoded image in a buffer in the frame memory 119). The frame memory 119 supplies the decoded image (or a part thereof) to the prediction unit 120 in response to a request of the prediction unit 120.

<Prediction Unit>

The prediction unit 120 performs processing related to generation of a predicted image. For example, the prediction unit 120 receives the prediction mode information Pinfo supplied from the control unit 101, the input image (original image) supplied from the sorting buffer 111, and the decoded image (or a part thereof) read from the frame memory 119. The prediction unit 120 performs prediction processing such as inter-prediction and intra-prediction using the prediction mode information Pinfo and the input image (original image), performs prediction by referring to the decoded image as a reference image, and performs motion compensation processing on the basis of the prediction result to generate a predicted image. The prediction unit 120 supplies the generated predicted image to the arithmetic operation unit 112 and the arithmetic operation unit 117. In addition, the prediction unit 120 supplies information regarding the prediction mode selected by the above processing, that is, the optimum prediction mode, to the coding unit 114 as necessary.

<Rate Control Unit>

The rate control unit 121 performs processing related to rate control. For example, the rate control unit 121 controls the rate of the quantization operation of the transform quantization unit 113 on the basis of the code amount of the coded data stored in the storage buffer 115 such that overflow or underflow does not occur.

<Transform Quantization Unit>

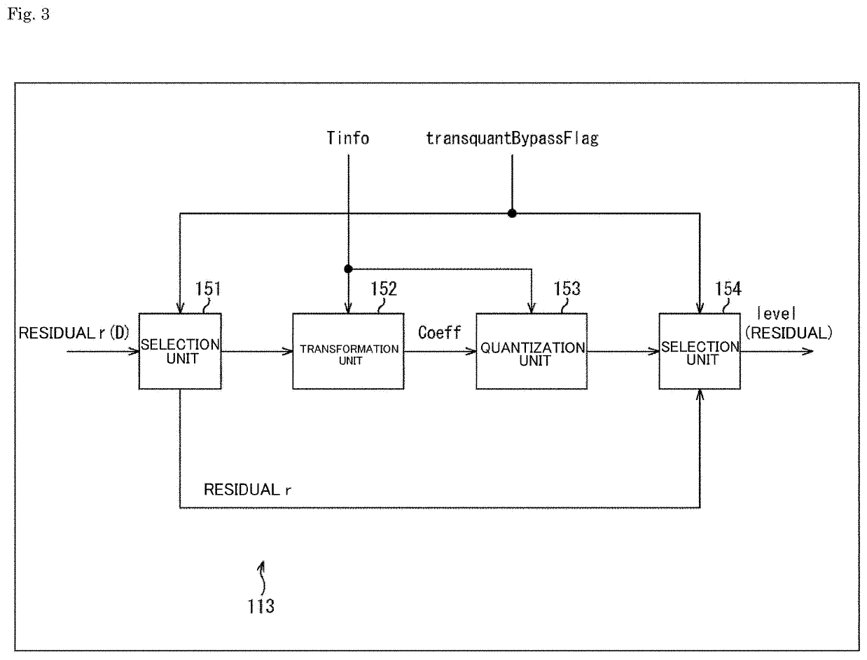

FIG. 3 is a block diagram showing an example of a main configuration of the transform quantization unit 113 of FIG. 2. As shown in FIG. 3, the transform quantization unit 113 includes a selection unit 151, a transformation unit 152, a quantization unit 153, and a selection unit 154.

The transformation unit 152 performs coefficient transformation on residual data r input via the selection unit 151 to generate a transform coefficient Coeff. The transformation unit 152 supplies the transform coefficient to the quantization unit 153.

The quantization unit 153 quantizes the transform coefficient Coeff supplied from the transformation unit 152 to generate a quantization coefficient level. The quantization unit 153 supplies the generated quantization coefficient level to the coding unit 114 and the inverse quantization inverse transformation unit 116 via the selection unit 154.

The selection unit 151 and the selection unit 154 select a supply source and a supply destination of residual data and a quantization coefficient on the basis of a transform quantization bypass flag (transquantBypassFlag), which is flag information indicating whether or not coefficient transformation and quantization are skipped (omitted), and the like.

For example, when the transform quantization bypass flag is false (for example, transquantBypassFlag==0) as in the non-lossless coding mode, the selection unit 151 acquires the residual data r (D) supplied from the arithmetic operation unit 112 and supplies the residual data r (D) to the transformation unit 152. In addition, the selection unit 154 acquires the quantization coefficient level supplied from the quantization unit 153 and supplies the quantization coefficient level to the coding unit 114 and the inverse quantization inverse transformation unit 116.

Further, when the transform quantization bypass flag is true (for example, transquantBypassFlag==1) as in the lossless coding mode, the selection unit 151 acquires the residual data r (D) supplied from the arithmetic operation unit 112 and supplies the residual data r (D) to the selection unit 154. In addition, the selection unit 154 acquires the residual data r (D) supplied from the selection unit 151 and supplies the residual data r (D) to the coding unit 114 and the inverse quantization inverse transformation unit 116.

<Setting of Maximum Transform Block Size>

In the image coding device 100 as described above, the control unit 101 can set a maximum transform block size in the lossless coding mode that is a mode in which lossless coding is applied to the same size as a transform coefficient group corresponding to a maximum transform block size in the non-lossless coding mode that is a mode in which lossless coding is not applied by applying the above-described method 1.

For example, in the case of VTM of NPL 1, the maximum transform block size (the maximum size of a TB) of the transformation unit 152 is 64×64. In such a case, high frequency components are zeroed out, and a transform coefficient group corresponding to 32×32 is generated and supplied to the quantization unit 153. That is, the maximum size of this transform coefficient group is 32×32, and the maximum size of a quantization coefficient group output from the quantization unit 153 is also 32×32. That is, a buffer size of 32*32*16 bits=16,384 bits is necessary to hold transform coefficients.

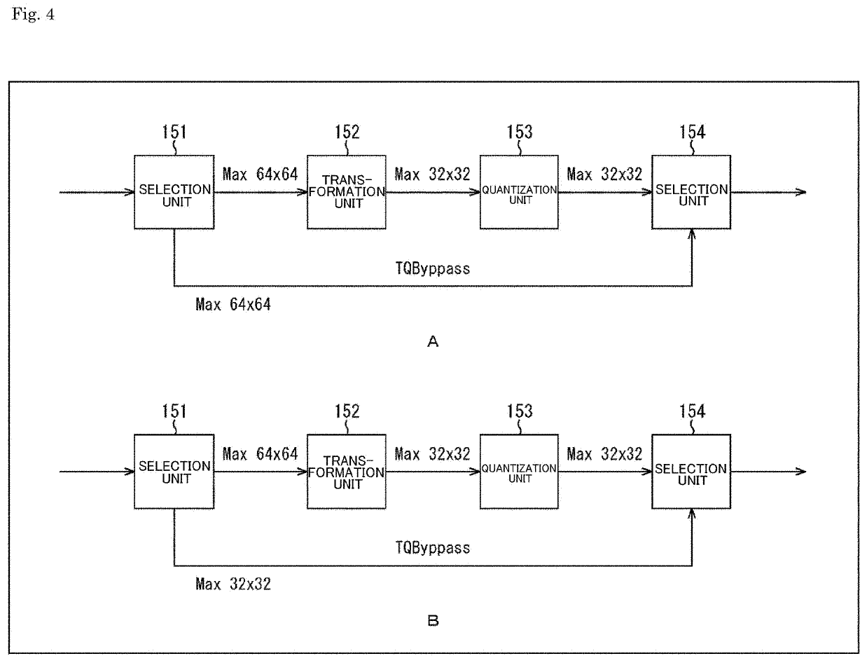

On the other hand, in the case of the lossless coding mode described in NPL 2, the buffer size for holding transform coefficients is expanded to 64×64 in order to support 128×128 CUs. That is, as shown in A of FIG. 4, the maximum transform block size (the maximum size of a TB) in the lossless coding mode is 64×64. That is, a buffer size of 64*64*16 bits=65,536 bits is necessary to hold transform coefficients.

On the other hand, in the case of the above-described method 1, the maximum transform block size of the lossless coding mode is set to the same size as a transform coefficient group corresponding to the maximum transform block size of the non-lossless coding mode. For example, in the case of A of FIG. 4, the maximum size of the transform coefficient group is 32×32 as described above. Therefore, as shown in B of FIG. 4, the maximum transform block size of the lossless coding mode is set to 32×32.

In this way, the buffer size necessary in the lossless coding mode can be set the same as the buffer size necessary in the non-lossless coding mode, and thus an increase in a coding load can be curbed. Further, this makes it possible to curb an increase in the circuit scale and cost of a device performing coding.

<Flow of Image Coding Processing>

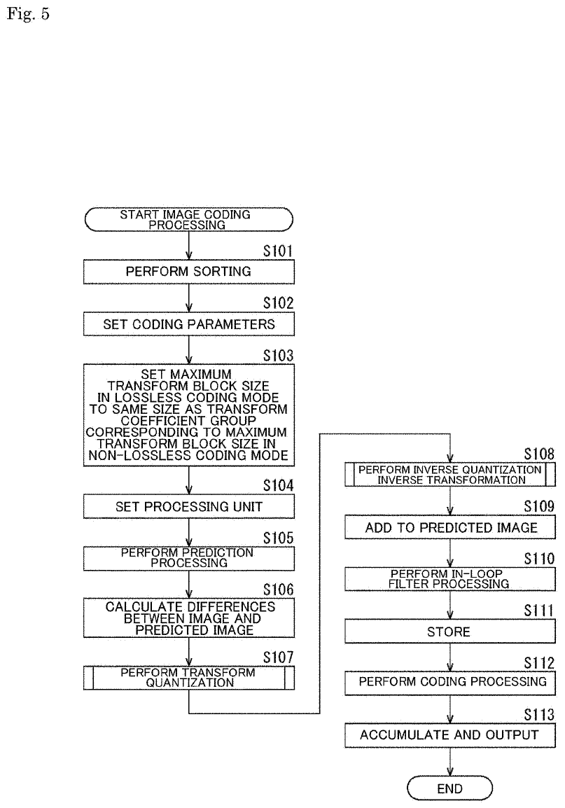

Next, a flow of processing executed by the image coding device 100 as described above will be described. First, an example of a flow of image coding process will be described with reference to the flowchart of FIG. 5.

When image coding processing is started, the sorting buffer 111 is controlled by the control unit 101 to sort the order of frames of input moving image data from a display order into a coding order in step S101.

In step S102, the control unit 101 determines (sets) coding parameters with respect to the input image held by the sorting buffer 111.

In step S103, the control unit 101 sets a maximum transform block size in the lossless coding mode to the same size as a transform coefficient group corresponding to a maximum transform block size in the non-lossless coding mode. For example, when the transform coefficient group corresponding to the maximum transform block size of 64×64 in the non-lossless coding mode is 32×32, the control unit 101 sets the maximum transform block size in the lossless coding mode to 32×32.

In step S104, the control unit 101 sets a processing unit (performs block division) for the input image held by the sorting buffer 111.

In step S105, the prediction unit 120 performs prediction processing to generate a predicted image or the like in an optimum prediction mode. For example, in this prediction processing, the prediction unit 120 performs intra-prediction to generate a predicted image or the like in an optimum intra-prediction mode, performs inter-prediction to generate a predicted image or the like in an optimum inter-prediction mode, and selects an optimum prediction mode from the prediction modes on the basis of a cost function value and the like.

In step S106, the arithmetic operation unit 112 calculates a difference between the input image and the predicted image in the optimum mode selected by prediction processing in step S105. That is, the arithmetic operation unit 112 generates residual data D between the input image and the predicted image. The amount of the residual data D obtained in this manner is reduced as compared to original image data. Therefore, the amount of data can be compressed as compared to a case where the image is coded as it is.

In step S107, the transform quantization unit 113 performs transform quantization processing on the residual data D generated by processing of step S106 according to the transformation mode information generated in step S102.

In step S108, the inverse quantization inverse transformation unit 116 performs inverse quantization inverse transformation processing. This inverse quantization inverse transformation processing is inverse processing of transform quantization processing in step S17, and the same processing is executed on the decoding side (image decoding device 200) which will be described later. Therefore, this inverse quantization inverse transformation processing will be described when the decoding side (image decoding device 200) will be described. The description can be applied to this inverse quantization inverse transformation processing (step S108). According to this processing, the inverse quantization inverse transformation unit 116 appropriately performs inverse quantization and inverse coefficient transformation on input coefficient data (quantization coefficient level or residual data r (D)) to generate residual data D′.

In step S109, the arithmetic operation unit 117 generates a locally decoded image by adding the predicted image obtained by prediction processing of step S105 to the residual data D′ obtained by inverse quantization inverse transformation processing of step S108.

In step S110, the in-loop filter unit 118 performs in-loop filter processing on the locally decoded image derived by processing of step S109.

In step S111, the frame memory 119 stores the locally decoded image derived by processing of step S109 and the locally decoded image filtered in step S110.

In step S112, the coding unit 114 codes the quantization coefficient level or the residual data D obtained by transform quantization processing of step S107 to generate coded data. At this time, the coding unit 114 codes various coding parameters (header information Hinfo, prediction mode information Pinfo, and transformation information Tinfo). Further, the coding unit 114 derives residual information RInfo from the quantization coefficient level and the residual data D and codes the residual information RInfo.

In step S113, the storage buffer 115 stores the coded data obtained in this manner and outputs the coded data, for example, as a bitstream, to the outside of the image coding device 100. This bitstream is transmitted to the decoding side via, for example, a transmission line or a recording medium. In addition, the rate control unit 121 performs rate control as necessary. When processing of step S113 ends, image coding processing ends.

<Flow of Transform Quantization Processing>

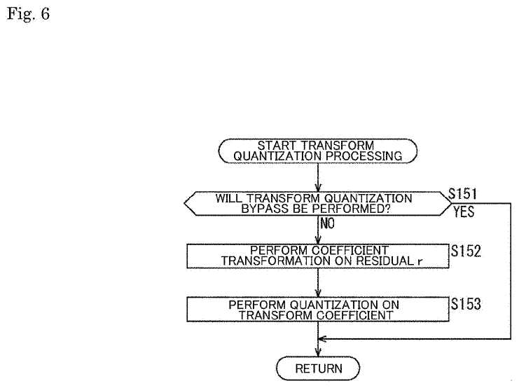

Next, an example of a flow of transform quantization processing executed in step S107 of FIG. 5 will be described with reference to the flowchart of FIG. 6.

When transform quantization processing is started, the selection unit 151 and the selection unit 154 determine whether or not to perform transform quantization bypass in step S151. If it is determined that transform quantization bypass is not performed (that is, if transquantBypassFlag==0), processing proceeds to step S152.

In step S152, the transformation unit 152 performs coefficient transformation on the residual data r to generate a transform coefficient. This coefficient transformation method is arbitrary.

In step S153, the quantization unit 153 quantizes the transform coefficient generated in step S152 to generate a quantization coefficient level. When processing of step S153 ends, transform quantization processing ends and processing returns to FIG. 5. That is, in this case, the quantization coefficient level is supplied to the coding unit 114 and the inverse quantization inverse transformation unit 116.

In addition, if it is determined that transform quantization bypass is performed (that is, if transquantBypassFlag==1) in step S151, processing of step S152 and processing of step S153 are skipped (omitted), transform quantization processing ends, and processing returns to FIG. 5. That is, in this case, the residual data D is supplied to the coding unit 114 and the inverse quantization inverse transformation unit 116.

By performing processing as described above, the buffer size necessary in the lossless coding mode can be set to the same as the buffer size necessary in the non-lossless coding mode, and thus an increase in a coding load can be curbed. Further, this makes it possible to curb an increase in the circuit scale and cost of a device performing coding.

### 3. Second Embodiment

<Image Decoding Device>

The present technology described in <1. Control of maximum transform block size in lossless coding mode> can also be applied to an image decoding device that decodes coded data of the image data.

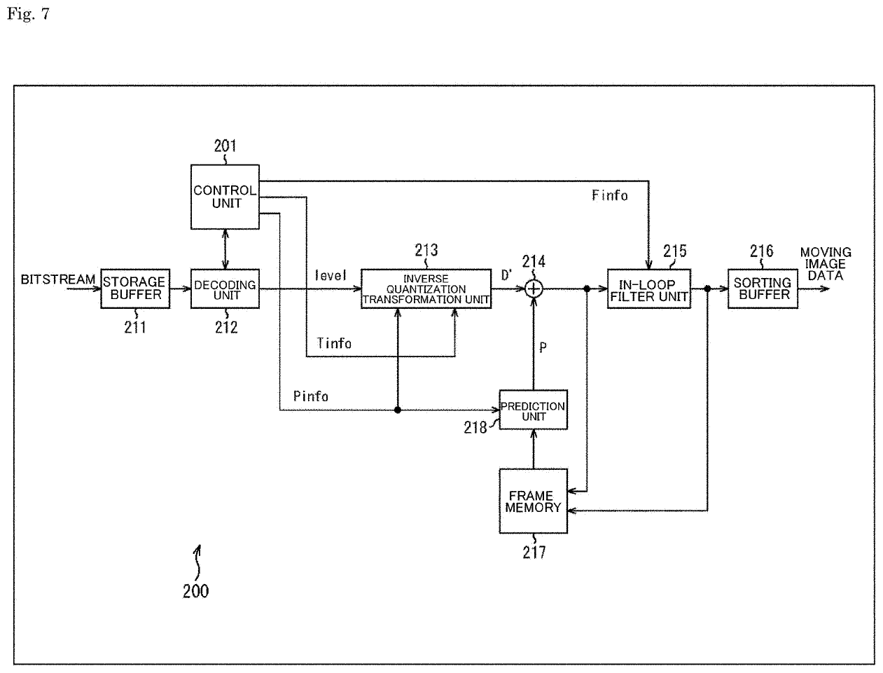

FIG. 7 is a block diagram showing an example of a configuration of an image decoding device, which is an aspect of an image processing device to which the present technology is applied. The image decoding device 200 shown in FIG. 7 is a device that decodes coded data of a moving image. For example, the image decoding device 200 decodes coded data of a moving image coded by a coding method such as VVC, AVC, HEVC, or the like described in the above-mentioned NPL. For example, the image decoding device 200 can decode coded data (bitstreams) generated by the image coding device 100 described above.

FIG. 7 does not show all parts but shows only principal parts of processing units and data flows. That is, the image decoding device 200 may include a processing unit that is not shown as a block in FIG. 7 or processing or a data flow that is not shown as an arrow or the like in FIG. 7. This also applies to other figures illustrating the processing units and the like in the image decoding device 200.

In FIG. 7, the image decoding device 200 includes a control unit 201, a storage buffer 211, a decoding unit 212, an inverse quantization inverse transformation unit 213, an arithmetic operation unit 214, an in-loop filter unit 215, a sorting buffer 216, a frame memory 217, and a prediction unit 218. The prediction unit 218 includes an intra-prediction unit and an inter-prediction unit that are not shown.

<Control Unit>

The control unit 201 performs processing related to decoding control. For example, the control unit 201 acquires coding parameters (header information Hinfo, prediction mode information Pinfo, transformation information Tinfo, residual information Rinfo, filter information Finfo, and the like) included in a bitstream via the decoding unit 212. In addition, the control unit 201 can estimate coding parameters that are not included in the bitstream. Further, the control unit 201 controls decoding by controlling each processing unit (the storage buffer 211 to the prediction unit 218) of the image decoding device 200 on the basis of the acquired (or estimated) coding parameters.

For example, the control unit 201 supplies the header information Hinfo to the inverse quantization inverse transformation unit 213, the prediction unit 218, and the in-loop filter unit 215. In addition, the control unit 201 supplies the prediction mode information Pinfo to the inverse quantization inverse transformation unit 213 and the prediction unit 218. Further, the control unit 201 supplies the transformation information Tinfo to the inverse quantization inverse transformation unit 213. In addition, the control unit 201 supplies the residual information Rinfo to the decoding unit 212. Further, the control unit 201 supplies the filter information Finfo to the in-loop filter unit 215.

Of course, the above-described example is an example and is not limited to this example. For example, each coding parameter may be supplied to an arbitrary processing unit. Further, other information may be supplied to an arbitrary processing unit.

<Header Information Hinfo>

The header information Hinfo includes header information such as a video parameter set (VPS)/a sequence parameter set (SPS)/a picture parameter set (PPS)/a picture header (PH)/a slice header (SH). The header information Hinfo includes, for example, information for defining an image size (width PicWidth and height PicHeight), a bit depth (luminance bitDepthY and chrominance bitDepthC), a chrominance array type ChromaArrayType, a maximum value MaxCUSize/minimum value MinCUSize of a CU size, a maximum depth MaxQTDepth/minimum depth MinQTDepth of quad-tree division, a maximum depth MaxBTDepth/minimum depth MinBTDepth of binary tree division, a maximum value MaxTSSize of a transformation skip block (also called a maximum transformation skip block size), an on/off flag (also called enable flags) of each coding tool, and the like.

For example, the on/off flag of a coding tool included in the header information Hinfo includes on/off flags related to transformation and quantization processing shown below. The on/off flag of a coding tool can also be interpreted as a flag indicating whether or not a syntax related to the coding tool is present in coded data. Further, when the value of the on/off flag is 1 (true), it indicates that the coding tool is available, and when the value of the on/off flag is 0 (false), it indicates that the coding tool is not available. The interpretation of the flag value may be reversed.

<Prediction Mode Information Pinfo>

The prediction mode information Pinfo includes, for example, information such as size information PBSize (prediction block size) of a processing target PB (prediction block), intra-prediction mode information IPinfo, and motion prediction information MVinfo.

The intra-prediction mode information IPinfo includes, for example, prev_intra_luma_pred_flag, mpm_idx, rem_intra_pred_mode in JCTVC-W1005, 7.3.8.5 coding unit syntax, and a luminance intra-prediction mode IntraPredModeY derived from the syntax thereof, and the like.

In addition, the intra-prediction mode information IPinfo includes, for example, an inter-component prediction flag (ccp_flag (cclmp_flag)), a multi-class linear prediction mode flag (mclm_flag), a chrominance sample location type identifier (chroma_sample_loc_type_idx), a chrominance MPM identifier (chroma_mpm_idx), a luminance intra-prediction mode (IntraPredModeC) derived from these syntaxes, and the like.

The inter-component prediction flag (ccp_flag (cclmp_flag)) is flag information indicating whether or not to apply inter-component linear prediction. For example, when ccp_flag==1, it indicates that inter-component prediction is applied, and when ccp_flag==0, it indicates that inter-component prediction is not applied.

The multi-class linear prediction mode flag (mclm_flag) is information on a linear prediction mode (linear prediction mode information). More specifically, the multi-class linear prediction mode flag (mclm_flag) is flag information indicating whether or not to set a multi-class linear prediction mode. For example, the multi-class linear prediction mode indicates a 1-class mode (single class mode) (for example, CCLMP) when it is “0” and indicates a 2-class mode (multi-class mode) (for example, MCLMP) when it is “1”.

The chrominance sample location type identifier (chroma_sample_loc_type_idx) is an identifier for identifying a type of a pixel position of a chrominance component (also referred to as a chrominance sample location type).

This chrominance sample location type identifier (chroma_sample_loc_type_idx) is transmitted as (stored in) information (chroma_sample_loc_info ( )) regarding the pixel position of the chrominance component.

The chrominance MPM identifier (chroma_mpm_idx) is an identifier indicating which prediction mode candidate in a chrominance intra-prediction mode candidate list (intraPredModeCandListC) is designated as a chrominance intra-prediction mode.

The motion prediction information MVinfo includes, for example, information such as merge_idx, merge_flag, inter_pred_idc, ref_idx_LX, mvp_lX_flag, X={0,1}, mvd (refer to JCTVC-W1005, 7.3.8.6 prediction unit syntax, for example).

Of course, the information included in the prediction mode information Pinfo is arbitrary and information other than the information may be included.

<Transformation Information Tinfo>

The transformation information Tinfo includes, for example, the following information. Of course, the information included in the transformation information Tinfo is arbitrary and information other than this information may be included.

Width size TBWSize and height TBHSize of a processing target transform block: Logarithmic values log2TBWSize and log2TBHSize of TBWSize and TBHSize with a base of 2 are also possible.

Transformation skip flag (ts_flag): A flag indicating whether (inverse) primary transformation and (inverse) secondary transformation are skipped.

Scan identifier (scanIdx)

Quantization parameter (qp)

Quantization matrix (scaling_matrix): For example, JCTVC-W1005, 7.3.4 scaling list data syntax

<Residual Information Rinfo>

The residual information Rinfo (refer to 7.3.8.11 Residual coding syntax of JCTVC-W1005, for example) includes, for example, the following syntax.

cbf (coded_block_flag): Residual data presence/absence flag

last_sig_coeff_x_pos: Last non-zero coefficient X coordinate

last_sig_coeff_y_pos: Last non-zero coefficient Y coordinate

coded_sub_block_flag: Subblock non-zero coefficient presence/absence flag

sig_coeff_flag: Non-zero coefficient presence/absence flag

gr1_flag: A flag indicating whether the level of a non-zero coefficient is greater than 1 (also called GR1 flag) gr2_flag: A flag indicating whether the level of a non-zero coefficient is greater than 2 (also called GR2 flag) sign_flag: A positive or negative non-zero coefficient sign (also called a sign code)

coeff_abs_level_remaining: A residual level of a non-zero coefficient (also called a non-zero coefficient residual level),

etc.

Of course, the information included in the residual information Rinfo is arbitrary and information other than this information may be included.

<Filter Information Finfo>

The filter information Finfo includes, for example, control information related to each filter processing below.

Control information on a deblocking filter (DBF)

Control information on a pixel adaptive offset (SAO)

Control information on an adaptive loop filter (ALF)

Control information on other linear and non-linear filters

More specifically, for example, the filter information includes information for designating a picture to which each filter is applied and an area in the picture, filter On/Off control information for each CU, filter On/Off control information on boundaries of slices and tiles, and the like. Of course, the information included in the filter information Finfo is arbitrary and information other than this information may be included.

<Storage Buffer>

The storage buffer 211 acquires and holds (stores) a bitstream input to the image decoding device 200. The storage buffer 211 extracts coded data included in the stored bitstream at a predetermined timing or when predetermined conditions are satisfied and supplies the coded data to the decoding unit 212.

<Decoding Unit>

The decoding unit 212 performs processing related to image decoding. For example, the decoding unit 212 receives the coded data supplied from the storage buffer 211 and entropy-decodes (reversibly decodes) a syntax value of each syntax element from the bit string according to the definition of a syntax table to derive parameters.

The parameters derived from the syntax element and the syntax value of the syntax element include, for example, information such as header information Hinfo, prediction mode information Pinfo, transformation information Tinfo, residual information Rinfo, and filter information Finfo. That is, the decoding unit 212 parses (analyzes and acquires) this information from the bitstream.

Further, the decoding unit 212 performs such parsing according to control of the control unit 201. Then, the decoding unit 212 supplies the information obtained by parsing to the control unit 201.

Further, the decoding unit 212 decodes the coded data with reference to the residual information Rinfo. At that time, the decoding unit 212 applies entropy decoding (reversible decoding) such as CABAC or CAVLC. That is, the decoding unit 212 decodes the coded data through a decoding method corresponding to the coding method performed by the coding unit 114 of the image coding device 100.

For example, it is assumed that CABAC is applied. In the case of the non-lossless coding mode, the decoding unit 212 performs arithmetic decoding using a context model on the coded data to derive a quantization coefficient level of each coefficient position in each transform block. The decoding unit 212 supplies the derived quantization coefficient level to the inverse quantization inverse transformation unit 213.

In addition, in the case of the lossless coding mode, the decoding unit 212 performs arithmetic decoding on the coded data in the bypass mode to derive residual data D. The decoding unit 212 supplies the derived residual data D to the inverse quantization inverse transformation unit 213.

<Inverse Quantization Reverse Transformation Unit>

The inverse quantization inverse transformation unit 213 performs processing related to inverse quantization and inverse coefficient transformation. For example, in the case of the non-lossless coding mode, the inverse quantization inverse transformation unit 213 acquires the quantization coefficient level supplied from the decoding unit 212. The inverse quantization inverse transformation unit 213 scales (inversely quantizes) the acquired quantization coefficient level to derive a transform coefficient Coeff. The inverse quantization inverse transformation unit 213 performs inverse coefficient transformation such as inverse orthogonal transformation on the transform coefficient Coeff to derive residual data D′. The inverse quantization inverse transformation unit 213 supplies the residual data D′ to the arithmetic operation unit 214.

The inverse quantization inverse transformation unit 213 can skip (omit) the inverse quantization and inverse coefficient transformation. For example, in the case of the lossless coding mode, the inverse quantization inverse transformation unit 213 acquires the residual data D supplied from the decoding unit 212. The inverse quantization inverse transformation unit 213 skips (omits) inverse quantization and inverse coefficient transformation and supplies the residual data D to the arithmetic operation unit 214 as the residual data D′.

The inverse quantization inverse transformation unit 213 performs the processing according to control of the control unit 201. For example, the inverse quantization inverse transformation unit 213 can perform the processing on the basis of the prediction mode information Pinfo and the transformation information Tinfo supplied from the control unit 201.

<Arithmetic Operation Unit>

The arithmetic operation unit 214 performs processing related to addition of information on an image. For example, the arithmetic operation unit 214 receives the residual data D′ supplied from the inverse quantization inverse transformation unit 213 and a predicted image supplied from the prediction unit 218. The arithmetic operation unit 214 adds the residual data to and the predicted image (predicted signal) corresponding to the residual data to derive a locally decoded image. The arithmetic operation unit 214 supplies the derived locally decoded image to the in-loop filter unit 215 and the frame memory 217.

<In-Loop Filter Unit>

The in-loop filter unit 215 performs processing related to in-loop filter processing. For example, the in-loop filter unit 215 receives the locally decoded image supplied from the arithmetic operation unit 214 and the filter information Finfo supplied from the control unit 201. Meanwhile, information input to the in-loop filter unit 215 is arbitrary and information other than this information may be input.

The in-loop filter unit 215 appropriately filters the locally decoded image on the basis of the filter information Finfo. For example, the in-loop filter unit 215 applies four in-loop filters: a bilateral filter; a deblocking filter (DBF); an adaptive offset filter (sample adaptive offset (SAO)); and an adaptive loop filter (ALF) in this order. Which filter is applied and in which order they are applied are arbitrary and can be appropriately selected.

The in-loop filter unit 215 performs filter processing corresponding to filter processing performed by the coding side (for example, the in-loop filter unit 118 of the image coding device 100). Of course, filter processing performed by the in-loop filter unit 215 is arbitrary and is not limited to the above example. For example, the in-loop filter unit 215 may apply a Wiener filter or the like.

The in-loop filter unit 215 supplies the filtered locally decoded image to the sorting buffer 216 and the frame memory 217.

<Sorting Buffer>

The sorting buffer 216 receives the locally decoded image supplied from the in-loop filter unit 215 and retains (stores) it. The sorting buffer 216 reconstructs decoded images for each picture unit using the locally decoded image and holds the decoded image (stores the decoded images in the buffer). The sorting buffer 216 sorts the obtained decoded image from the decoding order into the reproduction order. The sorting buffer 216 outputs the sorted decoded image group to the outside of the image decoding device 200 as moving image data.

<Frame Memory>

The frame memory 217 performs processing related to storage of data regarding images. For example, the frame memory 217 receives the locally decoded image supplied from the arithmetic operation unit 214, reconstructs a decoded image for each picture unit, and stores it in a buffer in the frame memory 217.

Further, the frame memory 217 receives the in-loop filtered locally decoded image supplied from the in-loop filter unit 215, reconstructs a decoded image for each picture unit, and stores it in the buffer in the frame memory 217. The frame memory 217 appropriately supplies the stored decoded image (or a part thereof) to the prediction unit 218 as a reference image.

The frame memory 217 may store header information Hinfo, prediction mode information Pinfo, transformation information Tinfo, filter information Finfo, and the like related to generation of decoded images.

<Prediction Unit>

The prediction unit 218 performs processing related to generation of a predicted image. For example, the prediction unit 218 receives the prediction mode information Pinfo supplied from the control unit 201 and the decoded image (or a part thereof) read from the frame memory 217. The prediction unit 218 performs prediction processing in a prediction mode adopted at the time of coding on the basis of the prediction mode information Pinfo and generates a predicted image with reference to the decoded image as a reference image. The prediction unit 218 supplies the generated predicted image to the arithmetic operation unit 214.

<Inverse Quantization Reverse Transformation Unit>

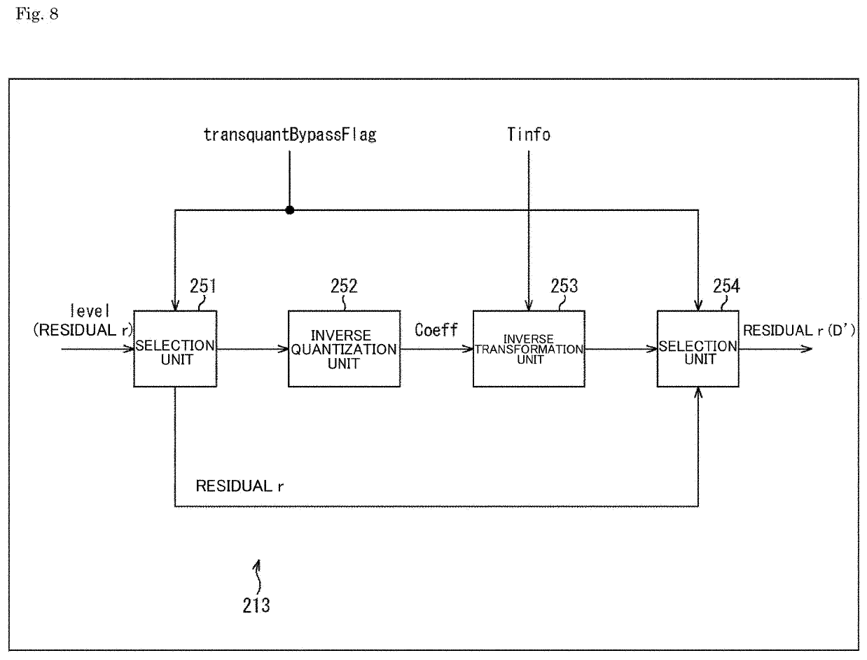

FIG. 8 is a block diagram showing an example of a main configuration of the inverse quantization inverse transformation unit 213 of FIG. 7. As shown in FIG. 8, the inverse quantization inverse transformation unit 213 includes a selection unit 251, an inverse quantization unit 252, an inverse transformation unit 253, and a selection unit 254.

The inverse quantization unit 252 inversely quantizes the quantization coefficient level input via the selection unit 251 to generate the transform coefficient Coeff. The inverse quantization unit 252 supplies the generated transform coefficient Coeff to the inverse transformation unit 253.

The inverse transformation unit 253 performs inverse coefficient transformation on the transform coefficient Coeff supplied from the inverse quantization unit 252 to generate residual data r (D′). The inverse transformation unit 253 supplies the residual data r (D′) to the arithmetic operation unit 214 via the selection unit 254.

The selection unit 251 and the selection unit 254 select a supply source and a supply designation of residual data and a quantization coefficient on the basis of a transform quantization bypass flag (transquantBypassFlag) that is flag information indicating whether or not inverse quantization and the inverse coefficient transformation are skipped (omitted), and the like.

For example, when the transform quantization bypass flag is false (for example, transquantBypassFlag==0) as in the non-lossless coding mode, the selection unit 251 acquires the quantization coefficient level supplied from the decoding unit 212 and supplies it to the inverse quantization unit 252. Further, the selection unit 254 acquires the residual data r (D′) supplied from the inverse transformation unit 253 and supplies it to the arithmetic operation unit 214.

In addition, when the transform quantization bypass flag is true (for example, transquantBypassFlag==1) as in the lossless coding mode, the selection unit 251 acquires the residual data r (D) supplied from the decoding unit 212 and supplies it to the selection unit 254. Further, the selection unit 254 acquires the residual data r (D) supplied from the selection unit 251 and supplies it to the arithmetic operation unit 214 as the residual data D′.

<Setting of Maximum Transform Block Size>

In the image decoding device 200 as described above, the control unit 201 can estimate the maximum transform block size in the lossless coding mode, which is a mode in which lossless coding is applied, as the same size as a transform coefficient group corresponding to a maximum transform block size in the non-lossless coding mode, which is a mode in which lossless coding is not applied by applying the above-described method 2.

Even in the case of decoding (inverse quantization inverse transformation), the maximum transform block size (the maximum size of a TB) is set to 64×64 in the lossless coding mode described in NPL 2, and a buffer size of 64*64*16 bits=65,536 bits (4 times the buffer size in the non-lossless coding mode) is necessary to hold transform coefficients, as in the case of coding (transform quantization) described with reference to A in FIG. 4.

On the other hand, in the case of decoding (inverse quantization inverse transformation) to which the above-described method 2 is applied, the maximum transform block size in the lossless coding mode is estimated as the same size as a transform coefficient group corresponding to the maximum transform block size in the non-lossless coding mode. Therefore, the maximum transform size in the lossless coding mode is set to 32×32, as in the case of coding (transform quantization) described with reference to B of FIG. 4.

In this way, the buffer size necessary in the lossless coding mode can be set to the same as the buffer size necessary in the non-lossless coding mode, and thus an increase in a decoding load can be curbed. Further, this makes it possible to curb an increase in the circuit scale and cost of a device performing decoding.

<Flow of Image Decoding Processing>

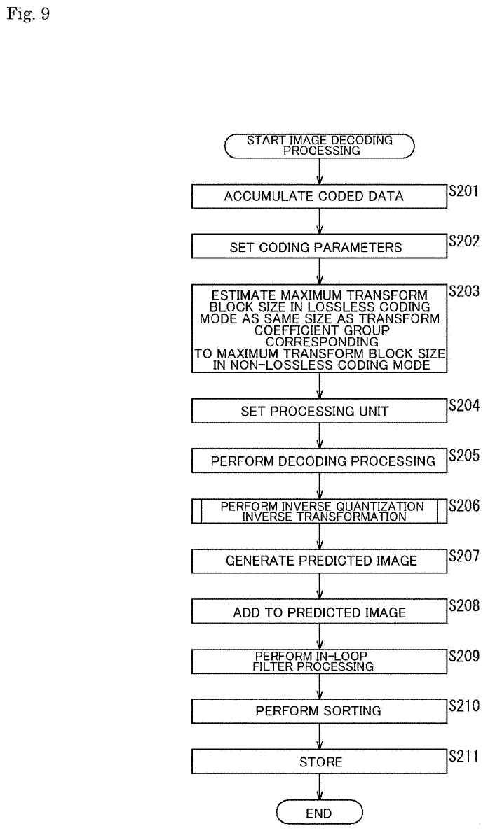

Next, a flow of processing executed by the image decoding device 200 as described above will be described. First, an example of a flow of image decoding processing will be described with reference to the flowchart of FIG. 9.

When image decoding processing is started, the storage buffer 211 acquires and holds (stores) a bitstream (coded data) supplied from the outside of the image decoding device 200 in step S201.

In step S202, the decoding unit 212 parses (analyzes and acquires) various coding parameters from the bitstream. The control unit 201 sets the various coding parameters by supplying the acquired various coding parameters to various processing units.

In addition, the control unit 201 estimates and sets coding parameters that are not included in the bitstream as necessary. For example, the control unit 201 estimates and sets a maximum transform block size in the lossless coding mode as the same size as a transform coefficient group corresponding to a maximum transform block size in the non-lossless coding mode in step S203.

In step S204, the control unit 201 sets a processing unit on the basis of the obtained coding parameters.

In step S205, the decoding unit 212 decodes the bitstream according to control of the control unit 201 to obtain coefficient data (a quantization coefficient level or residual data r). For example, when CABAC is applied, the decoding unit 212 performs arithmetic decoding using a context model to derive a quantization coefficient level of each coefficient position in each transform block in the case of the non-lossless coding mode. In addition, in the case of the lossless coding mode, the decoding unit 212 performs arithmetic decoding on the coded data in the bypass mode to derive residual data D.

In step S206, the inverse quantization inverse transformation unit 213 performs inverse quantization inverse transformation processing to generate residual data r (D′). Inverse quantization inverse transformation processing will be described later.

In step S207, the prediction unit 218 executes prediction processing through a prediction method designated by the coding side on the basis of the coding parameters and the like set in step S202 and generates a predicted image P by performing an operation of referring to reference images stored in the frame memory 217, or the like.

In step S208, the arithmetic operation unit 214 adds the residual data D′ obtained in step S206 to the predicted image P obtained in step S207 to derive a locally decoded image Rlocal.

In step S209, the in-loop filter unit 215 performs in-loop filter processing on the locally decoded image Rlocal obtained through processing in step S208.

In step S210, the sorting buffer 216 derives decoded images R using the locally decoded image Rlocal filtered through processing of step S209 and sorts the order of the group of the decoded images R from the decoding order to the reproduction order. The group of the decoded images R sorted in the reproduction order is output to the outside of the image decoding device 200 as a moving image.

In addition, the frame memory 217 stores at least one of the locally decoded image Rlocal obtained through processing of step S208 and the locally decoded image Rlocal filtered through processing of step S209 in step S211.

When processing of step S211 ends, image decoding processing ends.

<Flow of Inverse Quantization Inverse Transformation Processing>

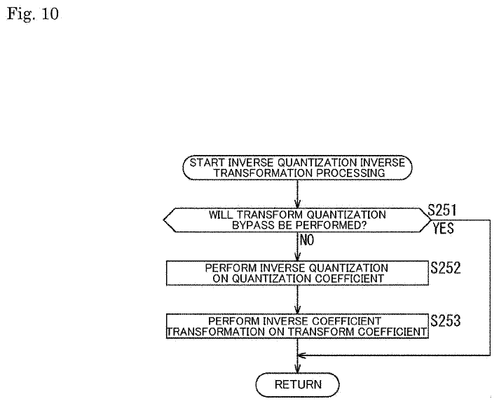

Next, an example of a flow of inverse quantization inverse transformation processing executed in step S206 of FIG. 9 will be described with reference to the flowchart of FIG. 10.

When inverse quantization inverse transformation processing is started, the selection unit 251 and the selection unit 254 determine whether or not to perform transform quantization bypass in step S251. If it is determined that transform quantization bypass is not performed (that is, if transquantBypassFlag==0), processing proceeds to step S252.

In step S252, the inverse quantization unit 252 performs inverse quantization on the quantization coefficient level to generate a transform coefficient Coeff.

In step S253, the inverse transformation unit 253 performs inverse coefficient transformation such as so-called inverse orthogonal transformation on the transform coefficient Coeff to generate residual data r (D′).

When processing of step S253 ends, inverse quantization inverse transformation processing ends and processing returns to FIG. 9.

Further, in step S251, if it is determined that the transformation quantization bypass is performed (that is, if transquantBypassFlag==1), processing of step S252 and processing of step 5253 are skipped (omitted), inverse quantization inverse transformation processing end, and processing returns to FIG. 9.

By performing processing as described above, the buffer size necessary in the lossless coding mode can be set to the same as the buffer size necessary in the non-lossless coding mode, and thus an increase in a decoding load can be curbed. Further, this makes it possible to curb an increase in the circuit scale and cost of a device performing decoding.

### 4. Control of Maximum Luminance Transform Block Size

<4-1. Control Based on Transform Quantization Bypass Mode Enable Flag>

In coding/decoding as described above, the maximum transform block size in the lossless coding mode may be controlled on the basis of a transform quantization bypass mode enable flag (transquant_bypass_enable_flag), which is flag information indicating whether the transform quantization bypass mode in which coefficient transformation and quantization are skipped is enabled.

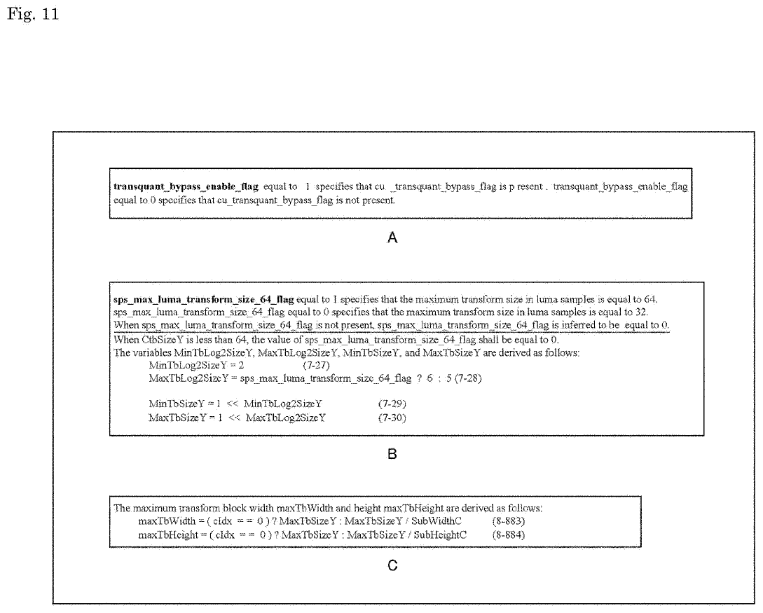

An example of the semantics of the transform quantization bypass mode enable flag (transquant_bypass_enable_flag) is shown in A of FIG. 11. If this flag is true (transquant_bypass_enable_flag=1), the transform quantization bypass flag (cu_transquant_bypass_flag) may be present. That is, the lossless coding mode is likely to be applied. On the other hand, if this flag is false (transquant_bypass_enable_flag=0), the transform quantization bypass flag (cu_transquant_bypass_flag) cannot be present. That is, the non-lossless coding mode is always applied.

For example, in the image coding device 100 of FIG. 2, the control unit 101 may set the maximum transform block size in the lossless coding mode to 32×32 on the basis of the transform quantization bypass mode enable flag (transquant_bypass_enable_flag). For example, when the transform quantization bypass mode enable flag is true (transquant_bypass_enable_flag=1), the lossless coding mode can be applied, and thus the control unit 101 may set the maximum transform block size to 32×32. Further, when transform quantization bypass mode enable flag is false (transquant_bypass_enable_flag=0), the non-lossless coding mode is always applied, and thus the control unit 101 may set the maximum transform block size to 64×64.

In this way, the maximum transform block size in the lossless coding mode can be easily set to 32×32.

In addition, in the image decoding device 200 of FIG. 7, for example, the control unit 201 may estimate the maximum transform block size in the lossless coding mode as 32×32 on the basis of the transform quantization bypass mode enable flag (transquant_bypass_enable_flag). For example, when the transform quantization bypass mode enable flag is true (transquant_bypass_enable_flag=1), the lossless coding mode can be applied, and thus the control unit 101 may estimate the maximum transform block size as 32×32. Further, when the transform quantization bypass mode enable flag is false (transquant_bypass_enable_flag=0), the non-lossless coding mode is always applied, and thus the control unit 101 may estimate the maximum transform block size as 64×64.

In this way, it is possible to easily estimate the maximum transform block size in the lossless coding mode as 32×32.

<4-2. Luminance Maximum Transform Block Size 64 Flag Signaling Control>

As shown in the third row from the top of the table of FIG. 1, signaling of a luminance maximum transform block size 64 flag (sps_max_luma_transform_size_64_flag) which is flag information indicating whether a luminance maximum transform block size is 64×64 is controlled on the basis of the transform quantization bypass mode enable flag (transquant_bypass_enable_flag) (method 1-2).

As shown in the tenth row from the top of the table of FIG. 1, estimation of the luminance maximum transform block size 64 flag (sps_max_luma_transform_size_64_flag) which is flag information indicating whether a luminance maximum transform block size is 64×64 is controlled on the basis of the transform quantization bypass mode enable flag (transquant_bypass_enable_flag) (method 2-2).

An example of the semantics of the luminance maximum transform block size 64 flag (sps_max_luma_transform_size_64_flag) is shown B of FIG. 11. If this flag is true (sps_max_luma_transform_size_64_flag=1), a maximum transform block size of a luminance component is set to 64×64. If this flag is false (sps_max_luma_transform_size_64_flag=0), the maximum transform block size of the luminance component is set to 32×32. If this flag is not signaled from the coding side to the decoding side, it is estimated that the value of the flag is false (=0). That is, it is estimated that the maximum transform block size of the luminance component is 32×32. As shown in C of FIG. 11, a maximum value of each of the horizontal and vertical lengths of the transform block is derived on the basis of this maximum transform block size.

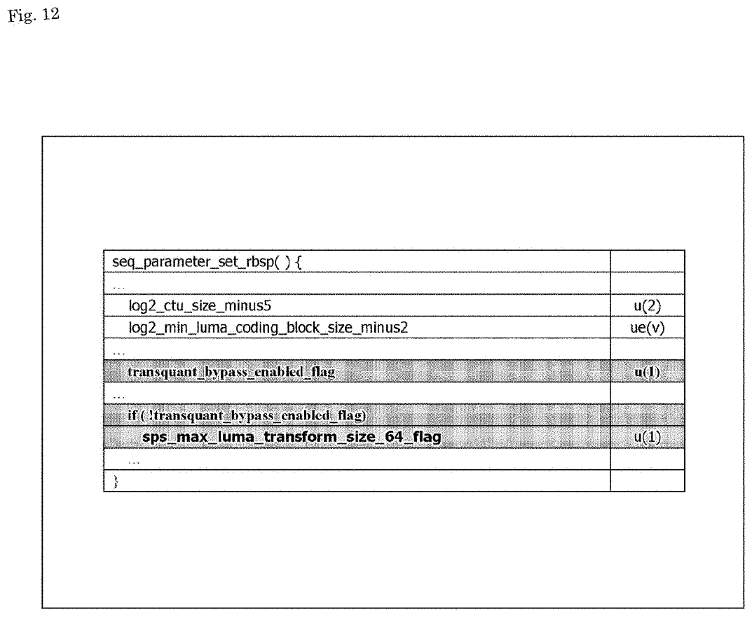

FIG. 12 is a diagram showing an example of a syntax when the aforementioned control is performed. In the case of this syntax, the luminance maximum transform block size 64 flag is signaled only when the transform quantization bypass mode enable flag is false.

if (!transquant_bypass_enable_flag){

sps_max_luma_transform_size_64_flag

}

As described above, in the image coding device 100 of FIG. 2, the control unit 101 may skip signaling of the luminance maximum transform block size 64 flag (sps_max_luma_transform_size_64_flag) when the transform quantization bypass mode enable flag is true (transquant_bypass_enable_flag=1). In other words, the control unit 101 may signal the luminance maximum transform block size 64 flag (sps_max_luma_transform_size_64_flag) only when the transform quantization bypass mode enable flag is false (transquant_bypass_enable_flag=0). Then, the coding unit 114 may code the luminance maximum transform block size 64 flag (sps_max_luma_transform_size_64_flag) according to the control.

In this way, the maximum transform block size in the lossless coding mode can be easily set to 32×32.

In addition, in the image decoding device 200 of FIG. 7, for example, the control unit 201 may cause decoding of the luminance maximum transform block size 64 flag (sps_max_luma_transform_size_64_flag) to be omitted and estimate that the maximum transform block size of the luminance component is 32×32 when the transform quantization bypass mode enable flag is true (transquant_bypass_enable_flag=1). In other words, the control unit 201 may cause the luminance maximum transform block size 64 flag (sps_max_luma_transform_size_64_flag) to be decoded only when the transform quantization bypass mode enable flag is false (transquant_bypass_enable_flag=0). Then, the decoding unit 212 may decode the luminance maximum transform block size 64 flag (sps_max_luma_transform_size_64_flag) according to the control.

In this way, it is possible to easily estimate the maximum transform block size in the lossless coding mode as 32×32.

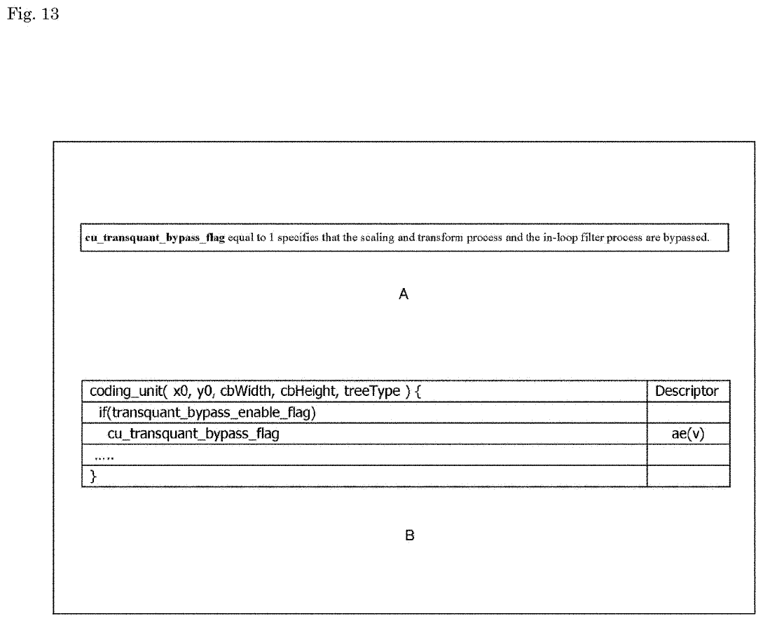

An example of the semantics of a transform quantization bypass flag (cu_transquant_bypass_flag) is shown in A of FIG. 13. An example of the syntax of the transform quantization bypass flag (cu_transquant_bypass_flag) is shown in B of FIG. 13.

<4-3. Luminance Maximum Transform Block Size Control Based on Transform Quantization Bypass Mode Enabled Flag and Luminance Maximum Transform Block Size 64 Flag>

As shown in the fourth row from the top of the table of FIG. 1, the luminance maximum transform block size may be controlled on the basis of the transform quantization bypass mode enable flag (transquant_bypass_enable_flag) and the luminance maximum transform block size 64 flag (sps_max_luma_transform_size_64_flag) (method 1-3).

As shown in the eleventh row from the top of the table of FIG. 1, the luminance maximum transform block size is estimated on the basis of the transform quantization bypass mode enable flag (transquant_bypass_enable_flag) and the luminance maximum transform block size 64 flag (sps_max_luma_transform_size_64_flag) (method 2-3).

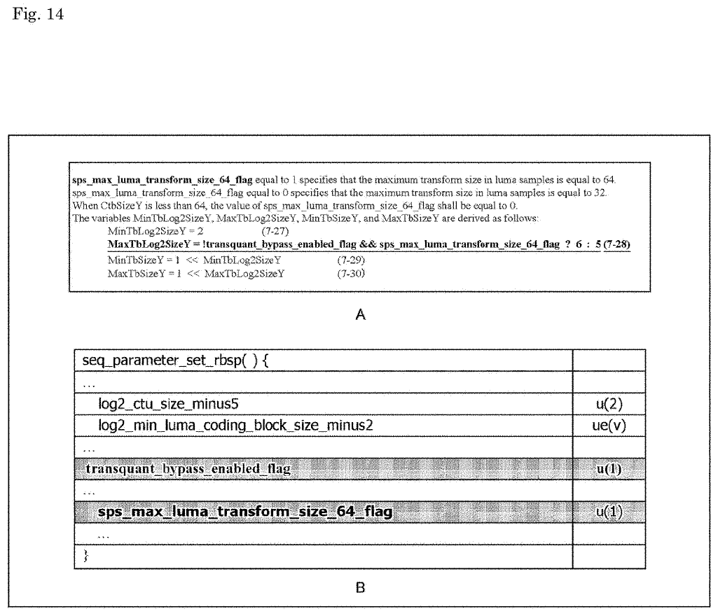

An example of the semantics of the luminance maximum transform block size 64 flag (sps_max_luma_transform_size_64_flag) in this case is shown in A of FIG. 14. Further, an example of the syntaxes of the transform quantization bypass mode enable flag (transquant_bypass_enable_flag) and the luminance maximum transform block size 64 flag (sps_max_luma_transform_size_64_flag) is shown in B of FIG. 14.

As shown in B of FIG. 14, in this case, the transform quantization bypass mode enable flag (transquant_bypass_enable_flag) and the luminance maximum transform block size 64 flag (sps_max_luma_transform_size_64_flag) are signaled independently of each other. In addition, as shown in A of FIG. 14, the luminance maximum transform block size (MaxTbLog2SizeY) is set to “6” (that is, 64×64) when the transform quantization bypass mode enable flag is false (! transquant_bypass_enable_flag) and the luminance maximum transform block size 64 flag is true (sps_max_luma_transform_size_64_flag=1) (when there is no possibility of the lossless coding mode and the luminance maximum transform block size is designated as 64×64) and set to “5” (that is, 32×32) in other cases (when there is a possibility of the lossless coding mode or the luminance maximum transform block size is designated as 32×32).

In this manner, in the image coding device 100 of FIG. 2, the control unit 101 may set the luminance maximum transform block size to 32×32 (MaxTbLog2SizeY=5) when the transform quantization bypass mode enable flag is true (transquant_bypass_enable_flag=1) or the luminance maximum transform block size 64 flag is false (sps_max_luma_transform_size_64_flag=0). In other words, the control unit 101 may set the luminance maximum transform block size to 64×64 (MaxTbLog2SizeY=6) when the transform quantization bypass mode enable flag is false (transquant_bypass_enable_flag=0) and the luminance maximum transform block size 64 flag is true (sps_max_luma_transform_size_64_flag=1).

In this way, the maximum transform block size in the lossless coding mode can be easily set to 32×32.

In addition, in the image decoding device 200 of FIG. 7, the control unit 201 may estimate the luminance maximum transform block size as 32×32 (MaxTbLog2SizeY=5) when the transform quantization bypass mode enable flag is true (transquant_bypass_enable_flag=1) or the luminance maximum transform block size 64 flag is false (sps_max_luma_transform_size_64_flag=0). In other words, the control unit 201 may estimate the luminance maximum transform block size as 64×64 (MaxTbLog2SizeY=6) when the transform quantization bypass mode enable flag is false (transquant_bypass_enable_flag=0) and the luminance maximum transform block size 64 flag is true (sps_max_luma_transform_size_64_flag=1).

In this way, it is possible to easily estimate the maximum transform block size in the lossless coding mode as 32×32.

### 5. Maximum Coded Tree Unit Size Control

<5-1. Control Based on Transform Quantization Bypass Mode Enable Flag>

The maximum transform block size may be controlled indirectly. For example, the maximum transform block size may be controlled by controlling maximum size of a coded tree unit (CTU). For example, the maximum CTU size of the lossless coding mode may be controlled on the basis of the transform quantization bypass mode enable flag (transquant_bypass_enable_flag).

For example, in the image coding device 100 of FIG. 2, when the transform quantization bypass mode enable flag is true (transquant_bypass_enable_flag=1), the lossless coding mode can be applied and thus the control unit 101 may set the maximum CTU size to 32×32. In addition, when the transform quantization bypass mode enable flag is false (transquant_bypass_enable_flag=0), the non-lossless coding mode is always applied and thus the control unit 101 may set the maximum CTU size to 64×64.

In this way, the maximum transform block size in the lossless coding mode can be easily set to 32×32.

For example, in the image decoding device 200 of FIG. 7, when the transform quantization bypass mode enable flag is true (transquant_bypass_enable_flag=1), the lossless coding mode can be applied and thus the control unit 201 may estimate the maximum CTU size as 32×32. Further, when the transform quantization bypass mode enable flag is false (transquant_bypass_enable_flag=0), the non-lossless coding mode is always applied and thus the control unit 201 may estimate the maximum CTU size as 64×64.

In this way, it is possible to easily estimate the maximum transform block size in the lossless coding mode as 32×32.

<5-2. Control of Signaling of Parameter Indicating Size of Coding Tree Unit>

There is log2_ctu_size_minus5 as a parameter indicating the CTU size. This parameter (log2_ctu_size_minus5) is a parameter indicating the CTU size by (log value−5).

As shown in the fifth row from the top of the table in FIG. 1, control of signaling of this parameter (log2_ctu_size_minus5) may be controlled on the basis of the transform quantization bypass mode enable flag (transquant_bypass_enable_flag) (method 1-4).

As shown in the twelfth row from the top of the table in FIG. 1, estimation of this parameter (log2_ctu_size_minus5) may be controlled on the basis of the transform quantization bypass mode enable flag (transquant_bypass_enable_flag) (method 2-4).

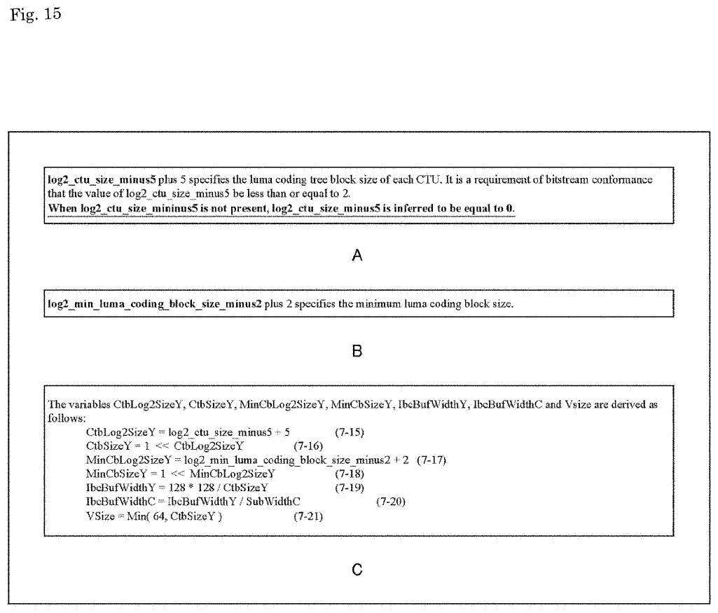

An example of the semantics of this parameter (log2_ctu_size_minus5) in that case is shown in A of FIG. 15. When the value of this parameter is 0 (log2_ctu_size_minus5=0), the CTU size is 32×32. Further, when this parameter is not signaled from the coding side to the decoding side, the value thereof is estimated as 0.

An example of the semantics of a parameter (log2_min_luma_codig_block_size_minus2) indicating a minimum size of a coding block (CB) of a luminance component is shown in B of FIG. 15. In addition, an example of semantics such as a parameter (CtbLog2SizeY) indicating the size of a coding tree block (CTB) derived using these parameters is shown in C of FIG. 15.

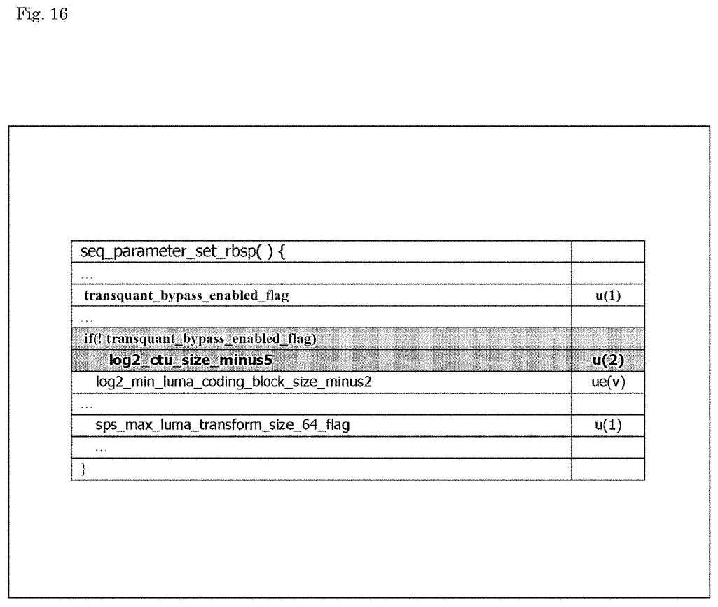

FIG. 16 is a diagram showing an example of a syntax when the aforementioned control is performed. In the case of this syntax, this parameter (log2_ctu_size_minus5) is signaled only when the transform quantization bypass mode enable flag is false.

if (!transquant_bypass_enable_flag){

log2_ctu_size_minus5

}

In this manner, in the image coding device 100 of FIG. 2, the control unit 101 may skip signaling of the parameter (log2_ctu_size_minus5) indicating the CTU size when the transform quantization bypass mode enable flag is true (transquant_bypass_enable_flag=1). In other words, the control unit 101 may signal the parameter (log2_ctu_size_minus5) indicating the CTU size only when the transform quantization bypass mode enable flag is false (transquant_bypass_enable_flag=0). Then, the coding unit 114 may code this parameter (log2_ctu_size_minus5) according to the control.

In this way, the maximum transform block size in the lossless coding mode can be easily set to 32×32.

Further, for example, in the image decoding device 200 of FIG. 7, the control unit 201 may cause decoding of the parameter (log2_ctu_size_minus5) indicating the CTU size to be omitted and estimate the maximum CTU size as 32×32 when the transform quantization bypass mode enable flag is true (transquant_bypass_enable_flag=1). In other words, the control unit 201 may decode this parameter (log2_ctu_size_minus5) only when the transform quantization bypass mode enable flag is false (transquant_bypass_enable_flag=0). Then, the decoding unit 212 may decode this parameter (log2_ctu_size_minus5) according to the control.

In this way, it is possible to easily estimate the maximum transform block size in the lossless coding mode as 32×32.

<5-3. Maximum Coding Tree Unit Size Control According to Bitstream Constraint>

As shown in the sixth row from the top of the table of FIG. 1, a bitstream constraint in which the maximum CTU size is set to 32×32 may be set and the maximum CTU size may be controlled on the basis of the constraint when the transform quantization bypass mode enable flag is true (transquant_bypass_enable_flag=1) (method 1-5).

As shown in the thirteenth row from the top of the table of FIG. 1, the maximum CTU size may be estimated on the basis of the bitstream constraint in which the maximum CTU size is 32×32 when the transform quantization bypass mode enable flag is true (transquant_bypass_enable_flag=1) (method 2-5).

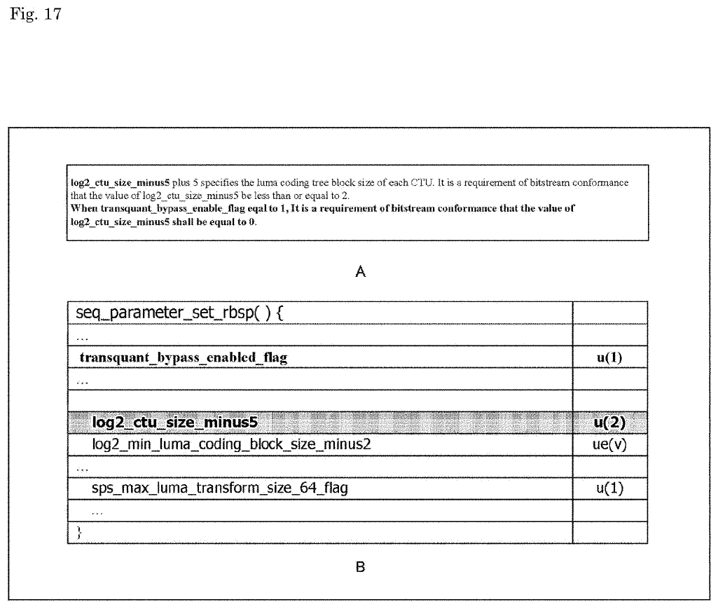

An example of the semantics of the parameter (log2_ctu_size_minus5) indicating the CTU size in this case is shown in A of FIG. 17. An example of the syntax of this parameter (log2_ctu_size_minus5) is shown in B of FIG. 17.

In the semantics of A in FIG. 17, a bitstream constraint in which the maximum CTU size is 32×32 when the transform quantization bypass mode enable flag is true (transquant_bypass_enable_flag=1) is set. Therefore, on the coding side, the maximum CTU size is set to 32×32 if the transform quantization bypass mode enable flag is true (transquant_bypass_enable_flag=1). On the decoding side, the maximum CTU size is estimated as 32×32 if the transform quantization bypass mode enable flag is true (transquant_bypass_enable_flag=1).

As described above, in the image coding device 100 of FIG. 2, the control unit 101 may set the maximum CTU size to 32×32 (log2_ctu_size_minus5=0) when the transform quantization bypass mode enable flag is true (transquant_bypass_enable_flag=1). In other words, the control unit 101 may set the maximum CTU size to 64×64 (log2_ctu_size_minus5=1) when the transform quantization bypass mode enable flag is false (transquant_bypass_enable_flag=0).

In this way, the maximum transform block size in the lossless coding mode can be easily set to 32×32.

In addition, in the image decoding device 200 of FIG. 7, the control unit 201 may estimate the maximum CTU size as 32×32 (log2_ctu_size_minus5=0) when the transform quantization bypass mode enable flag is true (transquant_bypass_enable_flag=1). In other words, the control unit 201 may estimate the maximum CTU size as 64×64 (log2_ctu_size_minus5=1) when the transform quantization bypass mode enable flag is false (transquant_bypass_enable_flag=0).

In this way, it is possible to easily estimate the maximum transform block size in the lossless coding mode as 32×32.

### 6. Control of Application of Lossless Coding Mode

<Coding Mode Control Based on Transform Quantization Bypass Mode Enable Flag and CU Size>

A coding mode may be controlled on the basis of a block size. For example, whether or not the lossless coding mode is applied may be controlled on the basis of the transform quantization bypass mode enable flag and the CU size.

As shown in the seventh row from the top of the table of FIG. 1, an applicable CU size of the lossless coding mode may be limited to 32×32 or less (method 1-6).

As shown in the fourteenth row from the top of the table of FIG. 1, it may be estimated that the coding mode is the non-lossless coding mode when the CU size is greater than 32×32 (method 2-6).

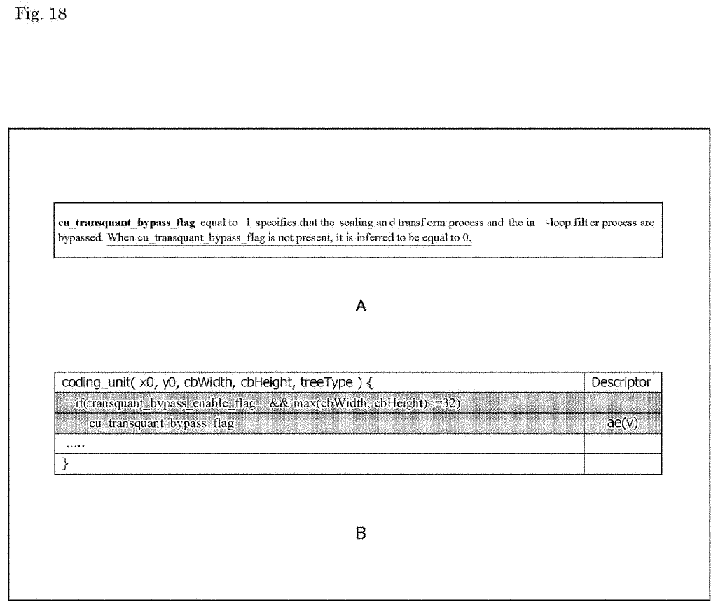

An example of the semantics of the transform quantization bypass flag (cu_transquant_bypass_flag) in that case is shown in A of FIG. 18. Further, an example of the syntax of the transform quantization bypass flag (cu_transquant_bypass_flag) is shown in B of FIG. 18.

As shown in A of FIG. 18, when the transform quantization bypass flag (cu_transquant_bypass_flag) is not signaled, it is estimated that the value thereof is false (cu_transquant_bypass_flag=0). Further, as shown in B of FIG. 18, only when the transform quantization bypass mode enable flag is true (transquant_bypass_enable_flag=1) and the CU size is 32×32 or less (the long side is 32 or less), the transform quantization bypass flag (cu_transquant_bypass_flag) is signaled.

In this manner, in the image coding device 100 of FIG. 2, the control unit 101 may skip signaling of the transform quantization bypass flag (cu_transquant_bypass_flag) (that is, apply the non-lossless coding mode) when the transform quantization bypass mode enable flag is false (transquant_bypass_enable_flag=0) or the CU size is greater than 32×32 (the long side is greater than 32). In other words, the control unit 101 may cause the transform quantization bypass flag (cu_transquant_bypass_flag) to be signaled only when the transform quantization bypass mode enable flag is true (transquant_bypass_enable_flag=1) and the CU size is 32×32 or less (the long side is 32 or less). Then, the coding unit 114 may code the transform quantization bypass flag (cu_transquant_bypass_flag) according to the control.

In this way, the maximum transform block size in the lossless coding mode can be easily set to 32×32.

In addition, in the image decoding device 200 of FIG. 7, for example, the control unit 201 may cause decoding of the transform quantization bypass flag (cu_transquant_bypass_flag) to be omitted (that is, apply the non-lossless coding mode) when the transform quantization bypass mode enable flag is false (transquant_bypass_enable_flag=0) or the CU size is greater than 32×32 (the long side is greater than 32). In other words, the control unit 201 may cause the transform quantization bypass flag (cu_transquant_bypass_flag) to be decoded only when the transform quantization bypass mode enable flag is true (transquant_bypass_enable_flag=1) and the CU size is 32×32 or less (the long side is 32 or less). Then, the decoding unit 212 may decode the transform quantization bypass flag (cu_transquant_bypass_flag) according to the control.

In this way, it is possible to easily estimate the maximum transform block size in the lossless coding mode as 32×32.

### 7. Supplement

<Computer>

The above-described series of processing can be executed by hardware or software. When the series of processing is performed by software, a program including the software is installed in a computer. Here, the computer includes a computer which is embedded in dedicated hardware or, for example, a general-purpose personal computer capable of executing various functions by installing various programs.

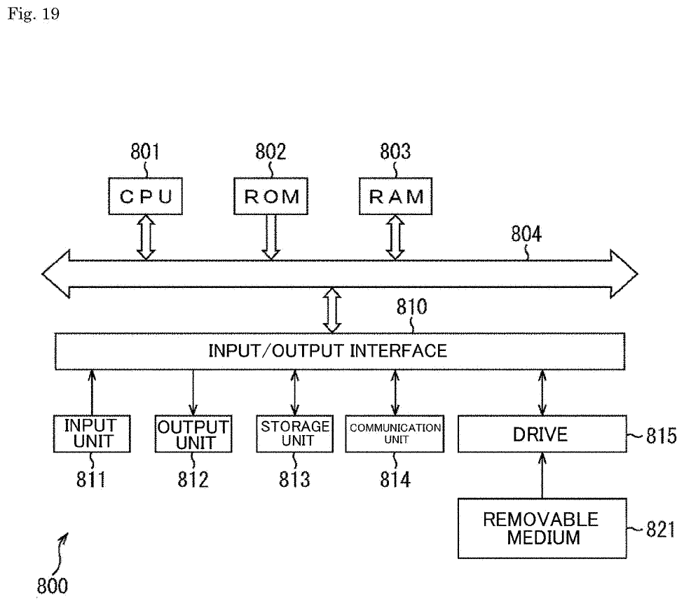

FIG. 19 is a block diagram showing an example of a hardware configuration of a computer that executes the above-described series of processing according to a program.

In a computer 800 shown in FIG. 19, a central processing unit (CPU) 801, a read-only memory (ROM) 802, and a random access memory (RAM) 803 are connected to each other via a bus 804.

An input/output interface 810 is also connected to the bus 804. An input unit 811, an output unit 812, a storage unit 813, a communication unit 814, and a drive 815 are connected to the input/output interface 810.

The input unit 811 includes, for example, a keyboard, a mouse, a microphone, a touch panel, an input terminal, and the like. The output unit 812 includes, for example, a display, a speaker, an output terminal, and the like. The storage unit 813 includes, for example, a hard disk, a RAM disc, a nonvolatile memory, and the like. The communication unit 814 includes, for example, a network interface. The drive 815 drives a removable medium 821 such as a magnetic disk, an optical disc, a magneto-optical disc, a semiconductor memory, or the like.

In the computer configured as described above, the CPU 801 performs the above-described series of processing, for example, by loading a program stored in the storage unit 813 on the RAM 803 via the input/output interface 810 and the bus 804 and executing the program. In the RAM 803, data or the like necessary for the CPU 801 to perform various kinds of processing is also appropriately stored.

For example, the program executed by the computer can be recorded on the removable medium 821 serving as a package medium for application. In this case, the program can be installed to the storage unit 813 via the input/output interface 810 by mounting the removable medium 821 in the drive 815.

The program can also be provided via a wired or wireless transmission medium such as a local area network, the Internet, or digital satellite broadcasting. In this case, the program can be received by the communication unit 814 and installed in the storage unit 813.

In addition, the program can also be installed in advance in the ROM 802 or the storage unit 813.

<Application Target of Present Technology>

The present technology can be applied to any image coding/decoding methods. That is, specifications of various types of processing related to image coding/decoding, such as transformation (inverse transformation), quantization (inverse quantization), coding (decoding), and prediction, are arbitrary and are not limited to the above-described examples as long as they do not contradict the above-described present technology. In addition, some of the various types of processing may be omitted as long as they do not contradict the above-described present technology.

Furthermore, the present technology can be applied to a multi-viewpoint image coding/decoding system that codes/decodes a multi-viewpoint image including images of a plurality of viewpoints (views). In that case, the present technology may be applied to coding/decoding of each viewpoint (view).

Moreover, the present technology can be applied to a hierarchical image coding (scalable coding)/decoding system that codes/decodes a hierarchical image layered so as to have a scalability function for a predetermined parameter. In that case, the present technology may be applied to coding/decoding of each layer.

Although the image coding device 100 and the image decoding device 200 have been described above as application examples of the present technology, the present technology can be applied to any configuration.

For example, the present technology can be applied to various electronic apparatuses such as a transmitter or a receiver (for example, a television receiver or a mobile phone) in satellite broadcasting, wired broadcasting such as cable TV, transmission on the Internet, transmission to a terminal through cellular communication, and the like, or a device (for example, a hard disk recorder or a camera) that records an image on media such as an optical disc, a magnetic disk, and a flash memory or reproduces an image from these storage media.

For example, the present technology can be implemented as a configuration of a part of a device such as a processor (for example, a video processor) of a system large scale integration (LSI), a module (for example, a video module) using a plurality of processors or the like, a unit (for example, a video unit) using a plurality of modules or the like, or a set (for example, a video set) with other functions added to the unit.

For example, the present technology can also be applied to a network system configured by a plurality of devices. For example, the present technology may be implemented as cloud computing shared or processed in cooperation with a plurality of devices via a network. For example, the present technology can be implemented in a cloud service providing a service related to images (moving images) to any terminal such as a computer, an audio visual (AV) device, a portable information processing terminal, or an Internet of things (IoT) device.

In the present specification, the system means a set of a plurality of constituent elements (devices, modules (components), or the like) and all the constituent elements may not be in the same casing. Accordingly, a plurality of devices accommodated in separate casings and connected via a network and a single device accommodating a plurality of modules in a single casing are all a system.

<Fields and Purposes to which Present Technology is Applicable>

A system, device, a processing unit, and the like to which the present technology is applied can be used in any field such as traffic, medical treatment, security, agriculture, livestock industries, a mining industry, beauty, factories, home appliance, weather, and natural surveillance, for example. Any purpose can be set.

For example, the present technology can be applied to systems and devices available for providing content for viewing and the like. In addition, for example, the present technology can be applied to systems and devices available for traffic, such as traffic condition monitoring and autonomous driving control. Further, for example, the present technology can be applied to systems and devices available for security. In addition, for example, the present technology can be applied to systems and devices available for automatic control of machines and the like. Further, for example, the present technology can be applied to systems and devices available for agriculture and livestock industry. In addition, the present technology can also be applied, for example, to systems and devices for monitoring natural conditions such as volcanoes, forests, and oceans and wildlife. Further, for example, the present technology can be applied to systems and devices available for sports.

<Others>

In the present specification, “flag” is information for identifying a plurality of states and includes not only information used to identify two states of true (1) and false (0) but also information for identifying three or more states. Accordingly, a value of the “flag” may be a binary value of 1/0 or may be, for example, a ternary value or the like. That is, any number of bits in the “flag” can be used and may be 1 bit or a plurality of bits. For identification information (also including the flag), it is assumed that the identification information is included in a bitstream and differential information of the identification information with respect to information serving as a certain standard is included in a bit steam. Therefore, in the present specification, the “flag” or the “identification information” includes not only the information but also differential information with respect to information serving as a standard.

Furthermore, various types of information (metadata and the like) about coded data (bitstreams) may be transmitted or recorded in any form as long as they are associated with the coded data. Here, the term “associate” means, for example, making other information available (linkable) when one piece of information is processed. That is, associated information may be collected as one piece of data or may be individual data. For example, information associated with coded data (image) may be transmitted on a transmission path different from that for the coded data (image). Further, for example, information associated with coded data (image) may be recorded on a recording medium (or another recording area of the same recording medium) different from that for the coded data (image). Meanwhile, this “association” may be for part of data, not the entire data. For example, an image and information corresponding to the image may be associated with a plurality of frames, one frame, or any unit such as a part in the frame.

In the present specification, terms such as “combining”, “multiplexing”, “adding”, “integrating”, “including”, “storing”, “putting into”, “entering”, and “inserting” mean that a plurality of things are collected as one, for example, coded data and meta data are collected as one piece of data and mean one method of the above-described “associating”.

Furthermore, embodiments of the present technology are not limited to the above-described embodiments and can be modified in various manners within the scope of the present technology without departing from the gist of the present technology.

For example, a configuration described as one device (or processing unit) may be divided and configured as a plurality of devices (or processing units). In contrast, the configuration described as the plurality of devices (or processing units) may be collected and configured as one device (or processing unit). A configuration other than the above-described configuration may be added to the configuration of each device (or each processing unit). Further, when the configuration or the operation are substantially the same in the entire system, a part of the configuration of a certain device (or processing unit) may be included in the configuration of another device (or another processing unit).

For example, the above-described program may be executed in any device. In this case, the device may have a necessary function (a functional block or the like) and may be able to obtain necessary information.

For example, each step of one flowchart may be executed by one device or may be shared and executed by a plurality of devices. Further, when a plurality of kinds of processing are included in one step, the plurality of kinds of processing may be performed by one device or may be shared and performed by a plurality of devices. In other words, a plurality of kinds of processing included in one step can also be executed as processing of a plurality of steps. In contrast, processing described as a plurality of steps can be collectively performed as one step.

For example, for a program executed by a computer, processing of steps of describing the program may be performed chronologically in order described in the present specification or may be performed in parallel or individually at a necessary timing such as the time of calling. That is, processing of each step may be performed in order different from the above-described order as long as inconsistency does not occur. Further, processing of steps describing the program may be performed in parallel to processing of another program or may be performed in combination with processing of another program.

For example, a plurality of technologies related to the present technology can be implemented independently alone as long as inconsistency does not occur. Of course, any plurality of technologies may be implemented together. For example, some or all of the present technologies described in several embodiments may be implemented in combination with some or all of the present technologies described in the other embodiments. Apart or all of any above-described present technology can also be implemented together with another technology which has not been described above.

The present technology can also be configured as follows.

(1) An image processing device including a control unit configured to set a maximum transform block size in a lossless coding mode to the same size as a transform coefficient group corresponding to a maximum transform block size in a non-lossless coding mode,

a transform quantization unit configured to generate a quantization coefficient by performing coefficient transformation and quantization on a predicted residual of an image in the case of the non-lossless coding mode and to skip the coefficient transformation and the quantization for the predicted residual in the case of the lossless coding mode, and

a coding unit configured to code the quantization coefficient generated by the transform quantization unit in the case of the non-lossless coding mode and to code the predicted residual in the case of the lossless coding mode.

(2) The image processing device according to (1), wherein the control unit sets the maximum transform block size in the lossless coding mode to 32×32.

(3) The image processing device according to (2), wherein the control unit sets the maximum transform block size in the lossless coding mode to 32×32 on the basis of a transform quantization bypass mode enable flag that is flag information indicating whether the mode in which the coefficient transformation and the quantization are skipped is enabled.

(4) The image processing device according to (3), wherein, when the transform quantization bypass mode enable flag is true, the control unit causes signaling of a luminance maximum transform block size 64 flag that is flag information indicating whether a luminance maximum transform block size is 64×64 to be skipped, and

the coding unit codes the luminance maximum transform block size 64 flag according to control of the control unit.

(5) The image processing device according to (3), wherein the control unit sets the luminance maximum transform block size to 32×32 when the transform quantization bypass mode enable flag is true or the luminance maximum transform block size 64 flag that is flag information indicating whether the luminance maximum transform block size is 64×64 is false.

(6) The image processing device according to (3), wherein the control unit controls a size of a coding tree unit on the basis of the transform quantization bypass mode enable flag.

(7) The image processing device according to (6), wherein the control unit causes signaling of a parameter indicating the size of the coding tree unit to be skipped when the transform quantization bypass mode enable flag is true, and the coding unit codes the parameter according to control of the control unit.

(8) The image processing device according to (6), wherein the control unit sets the size of the coding tree unit to 32×32 when the transform quantization bypass mode enable flag is true.

(9) The image processing device according to (3), wherein the control unit applies the non-lossless coding mode and causes signaling of the transform quantization bypass mode enable flag to be skipped when a size of a coding unit is greater than 32×32, and

the coding unit codes the transform quantization bypass mode enable flag according to control of the control unit.

(10) An image processing method including setting a maximum transform block size in a lossless coding mode to the same size as a transform coefficient group corresponding to a maximum transform block size in a non-lossless coding mode, generating a quantization coefficient by performing coefficient transformation and quantization on a predicted residual of an image in the case of the non-lossless coding mode and skipping the coefficient transformation and the quantization for the predicted residual in the case of the lossless coding mode, and

coding the generated quantization coefficient in the case of the non-lossless coding mode and coding the predicted residual in the case of the lossless coding mode.

(11) An image processing device including a control unit configured to estimate a maximum transform block size in a lossless coding mode as the same size as a transform coefficient group corresponding to a maximum transform block size in a non-lossless coding mode,

a decoding unit configured to decode coded data to generate a quantization coefficient in the case of the non-lossless coding mode and to decode the coded data to generate a predicted residual of an image in the case of the lossless coding mode, and

an inverse quantization inverse transformation unit configured to generate the predicted residual by performing inverse quantization and inverse coefficient transformation on the quantization coefficient generated by the decoding unit in the case of the non-lossless coding mode and to skip the inverse quantization and the inverse coefficient transformation for the predicted residual generated by the decoding unit in the case of the lossless coding mode.

(12) The image processing device according to (11), wherein the control unit estimates the maximum transform block size in the lossless coding mode as 32×32.

(13) The image processing device according to (12), wherein the control unit estimates the maximum transform block size in the lossless coding mode as 32×32 on the basis of a transform quantization bypass mode enable flag that is flag information indicating whether the mode in which the inverse quantization and the inverse coefficient transformation are skipped is enabled.

(14) The image processing device according to (13), wherein the control unit estimates that a luminance maximum transform block size 64 flag that is flag information indicating whether a luminance maximum transform block size is 64×64 is false when the transform quantization bypass mode enable flag is true.

(15) The image processing device according to (13), wherein the control unit estimates that the luminance maximum transform block size is 32×32 when the transform quantization bypass mode enable flag is true or the luminance maximum transform block size 64 flag that is flag information indicating whether the luminance maximum transform block size is 64×64 is false.

(16) The image processing device according to (13), wherein the control unit estimates a size of a coding tree unit on the basis of the transform quantization bypass mode enable flag.

(17) The image processing device according to (16), wherein the control unit causes decoding of a parameter indicating the size of the coding tree unit to be skipped when the transform quantization bypass mode enable flag is true.

(18) The image processing device according to (16), wherein the control unit sets the size of the coding tree unit to 32×32 when the transform quantization bypass mode enable flag is true.

(19) The image processing device according to (13), wherein the control unit applies the non-lossless coding mode and causes decoding of the transform quantization bypass mode enable flag to be skipped when a size of a coding unit is greater than 32×32,

(20) An image processing method including estimating a maximum transform block size in a lossless coding mode as the same size as a transform coefficient group corresponding to a maximum transform block size in a non-lossless coding mode,

decoding coded data to generate a quantization coefficient in the case of the non-lossless coding mode and decoding the coded data to generate a predicted residual of an image in the case of the lossless coding mode, and generating the predicted residual by performing inverse quantization and inverse coefficient transformation on the generated quantization coefficient in the case of the non-lossless coding mode and skipping the inverse quantization and the inverse coefficient transformation for the generated predicted residual in the case of the lossless coding mode.

### REFERENCE SIGNS LIST

100 Image coding device

101 Control unit

113 Transform quantization unit

114 Coding unit

200 Image decoding device

201 Control unit

212 Decoding unit

213 Inverse quantization inverse transformation unit

1. An image processing device comprising: a control unit configured to set a maximum transform block size in a lossless coding mode to the same size as a transform coefficient group corresponding to a maximum transform block size in a non-lossless coding mode;
a transform quantization unit configured to generate a quantization coefficient by performing coefficient transformation and quantization on a predicted residual of an image in the case of the non-lossless coding mode and to skip the coefficient transformation and the quantization for the predicted residual in the case of the lossless coding mode; and
a coding unit configured to code the quantization coefficient generated by the transform quantization unit in the case of the non-lossless coding mode and to code the predicted residual in the case of the lossless coding mode.

2. The image processing device according to claim 1, wherein the control unit sets the maximum transform block size in the lossless coding mode to 32×32.

3. The image processing device according to claim 2, wherein the control unit sets the maximum transform block size in the lossless coding mode to 32×32 on the basis of a transform quantization bypass mode enable flag that is flag information indicating whether the mode in which the coefficient transformation and the quantization are skipped is enabled.

4. The image processing device according to claim 3, wherein, when the transform quantization bypass mode enable flag is true, the control unit causes signaling of a luminance maximum transform block size 64 flag that is flag information indicating whether a luminance maximum transform block size is 64×64 to be skipped, and
the coding unit codes the luminance maximum transform block size 64 flag according to control of the control unit.

5. The image processing device according to claim 3, wherein the control unit sets the luminance maximum transform block size to 32×32 when the transform quantization bypass mode enable flag is true or the luminance maximum transform block size 64 flag that is flag information indicating whether the luminance maximum transform block size is 64×64 is false.

6. The image processing device according to claim 3, wherein the control unit controls a size of a coding tree unit on the basis of the transform quantization bypass mode enable flag.

7. The image processing device according to claim 6, wherein the control unit causes signaling of a parameter indicating the size of the coding tree unit to be skipped when the transform quantization bypass mode enable flag is true, and the coding unit codes the parameter according to control of the control unit.

8. The image processing device according to claim 6, wherein the control unit sets the size of the coding tree unit to 32×32 when the transform quantization bypass mode enable flag is true.

9. The image processing device according to claim 3, wherein the control unit applies the non-lossless coding mode and causes signaling of the transform quantization bypass mode enable flag to be skipped when a size of a coding unit is greater than 32×32, and
the coding unit codes the transform quantization bypass mode enable flag according to control of the control unit.

10. An image processing method comprising: setting a maximum transform block size in a lossless coding mode to the same size as a transform coefficient group corresponding to a maximum transform block size in a non-lossless coding mode;
generating a quantization coefficient by performing coefficient transformation and quantization on a predicted residual of an image in the case of the non-lossless coding mode and skipping the coefficient transformation and the quantization for the predicted residual in the case of the lossless coding mode; and
coding the generated quantization coefficient in the case of the non-lossless coding mode and coding the predicted residual in the case of the lossless coding mode.

11. An image processing device comprising: a control unit configured to estimate a maximum transform block size in a lossless coding mode as the same size as a transform coefficient group corresponding to a maximum transform block size in a non-lossless coding mode;
a decoding unit configured to decode coded data to generate a quantization coefficient in the case of the non-lossless coding mode and to decode the coded data to generate a predicted residual of an image in the case of the lossless coding mode; and
an inverse quantization inverse transformation unit configured to generate the predicted residual by performing inverse quantization and inverse coefficient transformation on the quantization coefficient generated by the decoding unit in the case of the non-lossless coding mode and to skip the inverse quantization and the inverse coefficient transformation for the predicted residual generated by the decoding unit in the case of the lossless coding mode.

12. The image processing device according to claim 11, wherein the control unit estimates the maximum transform block size in the lossless coding mode as 32×32.

13. The image processing device according to claim 12, wherein the control unit estimates the maximum transform block size in the lossless coding mode as 32×32 on the basis of a transform quantization bypass mode enable flag that is flag information indicating whether the mode in which the inverse quantization and the inverse coefficient transformation are skipped is enabled.

14. The image processing device according to claim 13, wherein the control unit estimates that a luminance maximum transform block size 64 flag that is flag information indicating whether a luminance maximum transform block size is 64×64 is false when the transform quantization bypass mode enable flag is true.

15. The image processing device according to claim 13, wherein the control unit estimates that the luminance maximum transform block size is 32×32 when the transform quantization bypass mode enable flag is true or the luminance maximum transform block size 64 flag that is flag information indicating whether the luminance maximum transform block size is 64×64 is false.

16. The image processing device according to claim 13, wherein the control unit estimates a size of a coding tree unit on the basis of the transform quantization bypass mode enable flag.

17. The image processing device according to claim 16, wherein the control unit causes decoding of a parameter indicating the size of the coding tree unit to be skipped when the transform quantization bypass mode enable flag is true.

18. The image processing device according to claim 16, wherein the control unit sets the size of the coding tree unit to 32×32 when the transform quantization bypass mode enable flag is true.

19. The image processing device according to claim 13, wherein the control unit applies the non-lossless coding mode and causes decoding of the transform quantization bypass mode enable flag to be skipped when a size of a coding unit is greater than 32×32.

20. An image processing method comprising: estimating a maximum transform block size in a lossless coding mode as the same size as a transform coefficient group corresponding to a maximum transform block size in a non-lossless coding mode; decoding coded data to generate a quantization coefficient in the case of the non-lossless coding mode and decoding the coded data to generate a predicted residual of an image in the case of the lossless coding mode; and generating the predicted residual by performing inverse quantization and inverse coefficient transformation on the generated quantization coefficient in the case of the non-lossless coding mode and skipping the inverse quantization and the inverse coefficient transformation for the generated predicted residual in the case of the lossless coding mode.
